(19) United States
(12) Patent Application Publication
(10) Pub. No.: US 2010/0260266 A1
(43) Pub. Date: Oct. 14, 2010

(54) FEC ALTERNATIVES TO THE REED-SOLOMON OUTER CODE

(75) Inventors: RALPH A. GHOLMIEH, San Diego, CA (US); Gordon K. Walker, Poway, CA (US)

Correspondence Address: McDermott Will & Emery LLP, 11682 El Camino Real, Suite 400, San Diego, CA, 92130, US

(73) Assignee: QUALCOMM Incorporated, San Diego, CA (US)

(21) Appl. No.: 12/756,922

(22) Filed: Apr. 8, 2010

Related U.S. Application Data
(60) Provisional application No. 61/168,423, filed on Apr. 10, 2009.

(51) Int. Cl. H04N 11/02

(52) U.S. Cl. 375/240.25; 375/240.01; 375/E07.026; 375/E07.027

(57) ABSTRACT

Methods, systems, and apparatus, including computer programs encoded on computer storage media for encoding data for transmission on a communication link of a content delivery system includes: receiving data to be communicated to a device, the data received as a multiple data link layer packets of a logical channel carrying broadcast data; encoding the multiple data link layer packets of the logical channel as one outer codeword using an outer code at an outer code rate; encoding symbols of the outer codeword with an inner code; and indicating the outer code and the outer code rate through signaling, including setting a first value for a first field of a control channel and setting a second value for a second field of the control channel, wherein the first value is determined by the outer code, and the second value is determined by the outer code rate.

### CROSS-REFERENCES TO RELATED APPLICATIONS

This application claims the benefit of U.S. Provisional Application No. 61/168,423, filed Apr. 10, 2009, entitled “FEC Alternatives to the Reed Solomon Outer Code,” which is herein incorporated by reference for all purposes.

### BACKGROUND

The following references are herein incorporated by reference in their entirety for all purposes:

U.S. Pat. No. 7,418,651, entitled: “File Download and Streaming System,” issued Aug. 26, 2008 to Luby, et al. (hereinafter “Luby”);

U.S. Patent Publication No. 2009/0271688, entitled “Communication Signal Decoding with Iterative Cooperation Between Inner and Outer Codes,” published Oct. 29, 2009, naming Jiang, et al. (hereinafter “Jiang”); and

M. R. Chari, F. Ling, A. Mantravadi, R. Krishnamoorthi, R. Vijayan, G. K. Walker, and R. Chandhok, “FLO physical layer: An Overview,” IEEE Trans. Broadcast., vol. 53, no. 1, pt. 2, pp. 145-160, March 2007 (hereinafter “Chari”).

A content delivery system can be or include a wireless content delivery system, such as the MediaFLO™ system developed by QUALCOMM Incorporated of San Diego, Calif. The content delivery system can be or include a content delivery platform based on wired or optical connections, in addition to or instead of a wireless interface. In general, the content delivered by the content delivery system can include video media, such as video clips encoded in the Real™ format, the Motion Pictures Group (.mpg) format, the Windows Media format by Microsoft Corp., or other video codec or format. The content can include audio media, such as music tracks or broadcast recordings encoded in Motion Pictures Expert Group (MPEG)-1 Audio Layer 3 (MP3) format, Microsoft Corp. “.wav” format, RealAudio™ format, or other audio codec or format. The content can further include textual content, such as streaming stock quotes, weather reports, or other data.

In a content delivery system, data can be transmitted via a set of logical channels. In some implementations, a set of logical channels can comprise a set of multicast logical channels (MLCs) such as those employed in the aforementioned MediaFLO™ system. The use of a set of logical channels can increase the time diversity of data received within a superframe. In some implementations, data from one flow can be distributed over multiple logical channels in the set of logical channels. In this case, a slot allocation algorithm at the transmission headend can be made aware of the contents of the logical channels. Time diversity or time separation between the slots carrying the logical channels can be maximized by that assignment algorithm. According to implementations in one regard, the receiving device can wake up to monitor the set of logical channels. In some implementations, different flows can be distributed over multiple different logical channels, or using other algorithms or criteria. For instance, the data transmitted over one logical channel can be scheduled in multiple blocks of slots. Block locations can be signaled in the overhead information symbols (OIS), or other signaling channels. In some implementations, multiple physical channels and/or a mix of logical and physical channels can be used for delivery of the transmission stream.

### SUMMARY

An example of a method of encoding data for transmission on a communication link of a content delivery system according to the disclosure includes: receiving data to be communicated to a device, the data received as a multiple data link layer packets of a logical channel carrying broadcast data; encoding the multiple data link layer packets of the logical channel as one outer codeword using an outer code at an outer code rate; encoding symbols of the outer codeword with an inner code; and indicating the outer code and the outer code rate through signaling, including setting a first value for a first field of a control channel and setting a second value for a second field of the control channel, wherein the first value is determined by the outer code, and the second value is determined by the outer code rate.

Implementations of such a method may include one or more of the following features. The outer code can be a Raptor code. The method can further include determining the outer code rate at least in part by the multiple data link layer packets of the logical channel.

An example of a method of encoding data for transmission on a communication link of a content delivery system includes: receiving data to be communicated to a device, the data received as a multiple data link layer packets of a logical channel carrying broadcast data; encoding the multiple data link layer packets of the logical channel as one outer codeword using an outer code at an outer code rate; encoding symbols of the outer codeword with an inner code; and indicating the outer code and the outer code rate through signaling, including setting a first value for a first field of a control channel, the first value determined by the outer code and a reference code rate, and signaling a difference between the outer code rate and the reference code rate using first overhead information symbols describing the logical channel, wherein the outer code rate is updatable on a superframe basis.

Implementations of such a method may include one or more of the following features. The method can further include indicating the difference between the outer code rate and the reference code rate using second overhead information symbols embedded in the logical channel. The outer code can be a Raptor code. The method can further include determining the outer code rate at least in part by the multiple data link layer packets of the logical channel.

An example of a method of encoding data for transmission on a communication link of a content delivery system includes: receiving data to be communicated to a device, the data received as a multiple data link layer packets of a logical channel carrying broadcast data; encoding the multiple data link layer packets of the logical channel as one outer codeword using an outer code at an outer code rate; encoding symbols of the outer codeword with an inner code; and indicating the outer code and the outer code rate through signaling, including signaling the outer code rate using overhead information symbols describing the logical channel, wherein the outer code rate is updatable on a superframe basis.

Implementations of such a method may include one or more of the following features. The outer code can be a Raptor code. The method can further include determining the outer code rate at least in part by the multiple data link layer packets of the logical channel.

An example of a method of decoding data transmitted on a communication link of a content delivery system includes: receiving data transmitted on the communication link; inner decoding the received data with an inner code; and outer decoding output of the inner decoding as one outer codeword using a Raptor code at an outer code rate, wherein the inner decoding is based on first extrinsic information produced by the outer decoding, and the outer decoding is based on second extrinsic information produced by the inner decoding.

An example of a method of encoding data for transmission on a communication link includes: receiving data to be communicated over a multiple superframes to a device, the data received as a multiple data link layer packets of a logical channel; encoding the multiple data link layer packets of the logical channel as one outer codeword using an outer code at an outer code rate; encoding symbols of the outer codeword with an inner code; and indicating the outer code, the outer code rate, and the multiple superframes of which the data are jointly encoded as the outer codeword using the outer code.

Implementations of such a method may include the feature where the communication link can be part of a content delivery system; and the outer code can be a Raptor code.

An example of an apparatus configured to encode data for transmission on a communication link of a content delivery system includes: an input configured to receive data to be communicated to a device, the data received as a multiple data link layer packets of a logical channel carrying broadcast data; an outer encoder communicatively coupled to the input and configured to encode the multiple data link layer packets of the logical channel as one outer codeword using an outer code at an outer code rate; an inner encoder communicatively coupled to the outer encoder and configured to encode symbols of the outer codeword with an inner code; and a processor communicatively coupled to the inner encoder and configured to indicate the outer code and the outer code rate through signaling, including setting a first value for a first field of a control channel and setting a second value for a second field of the control channel, wherein the first value is determined by the outer code, and the second value is determined by the outer code rate.

Implementations of such an apparatus may include one or more of the following features. The outer code can be a Raptor code. The processor can be further configured to determine the outer code rate at least in part by the multiple data link layer packets of the logical channel.

An example of an apparatus configured to encode data for transmission on a communication link of a content delivery system includes: an input configured to receive data to be communicated to a device, the data received as a multiple data link layer packets of a logical channel carrying broadcast data; an outer encoder communicatively coupled to the input and configured to encode the multiple data link layer packets of the logical channel as one outer codeword using an outer code at an outer code rate; an inner encoder communicatively coupled to the outer encoder and configured to encode symbols of the outer codeword with an inner code; and a processor communicatively coupled to the inner encoder and configured to indicate the outer code and the outer code rate through signaling, including setting a first value for a first field of a control channel, the first value determined by the outer code and a reference code rate, and signaling a difference between the outer code rate and the reference code rate using first overhead information symbols describing the logical channel, wherein the outer code rate is updatable on a superframe basis.

Implementations of such an apparatus may include one or more of the following features. The processor can be further configured to indicate the difference between the outer code rate and the reference code rate using second overhead information symbols embedded in the logical channel. The outer code can be a Raptor code. The processor can be further configured to determine the outer code rate at least in part by the multiple data link layer packets of the logical channel.

An example of an apparatus configured to encode data for transmission on a communication link of a content delivery system includes: an input configured to receive data to be communicated to a device, the data received as a multiple data link layer packets of a logical channel carrying broadcast data; an outer encoder communicatively coupled to the input and configured to encode the multiple data link layer packets of the logical channel as one outer codeword using an outer code at an outer code rate; an inner encoder communicatively coupled to the outer encoder and configured to encode symbols of the outer codeword with an inner code; and a processor communicatively coupled to the inner encoder and configured to indicate the outer code and the outer code rate through signaling, including signaling the outer code rate using overhead information symbols describing the logical channel, wherein the outer code rate is updatable on a superframe basis.

Implementations of such an apparatus may include one or more of the following features. The outer code can be a Raptor code. The processor can be further configured to determine the outer code rate at least in part by the multiple data link layer packets of the logical channel.

An example of an apparatus configured to decode data transmitted on a communication link of a content delivery system includes: an input configured to receive data transmitted on the communication link; an inner decoder communicatively coupled to the input and configured to decode the received data with an inner code; and an outer decoder communicatively coupled to the inner decoder and configured to decode output of the inner decoder as one outer codeword using a Raptor code at an outer code rate, wherein the inner decoding is based on first extrinsic information produced by the outer decoding, and the outer decoding is based on second extrinsic information produced by the inner decoding.

An example of an apparatus configured to encode data for transmission on a communication link includes: an input configured to receive data to be communicated over a multiple superframes to a device, the data received as a multiple data link layer packets of a logical channel; an outer encoder communicatively coupled to the input and configured to encode the multiple data link layer packets of the logical channel as one outer codeword using an outer code at an outer code rate; an inner encoder communicatively coupled to the outer encoder and configured to encode symbols of the outer codeword with an inner code; and a processor communicatively coupled to the inner encoder and configured to indicate the outer code, the outer code rate, and the multiple superframes of which the data are jointly encoded as the outer codeword by the outer encoder.

Implementations of such an apparatus may include the feature where the communication link can be part of a content delivery system; and the outer encoder can be a Raptor encoder.

An example of a computer program product includes a processor-readable medium storing processor-readable instructions configured to cause a processor to: receive data to be communicated to a device by transmission on a communication link of a content delivery system, the data received as a multiple data link layer packets of a logical channel carrying broadcast data; encode the multiple data link layer packets of the logical channel as one outer codeword using an outer code at an outer code rate; encode symbols of the outer codeword with an inner code; and indicate the outer code and the outer code rate through signaling, including setting a first value for a first field of a control channel and setting a second value for a second field of the control channel, wherein the first value is determined by the outer code, and the second value is determined by the outer code rate.

Implementations of such a product may include one or more of the following features. The outer code can be a Raptor code. The instructions can be further configured to cause the processor to determine the outer code rate at least in part by the multiple data link layer packets of the logical channel.

An example of a computer program product includes a processor-readable medium storing processor-readable instructions configured to cause a processor to: receive data to be communicated to a device by transmission on a communication link of a content delivery system, the data received as a multiple data link layer packets of a logical channel carrying broadcast data; encode the multiple data link layer packets of the logical channel as one outer codeword using an outer code at an outer code rate; encode symbols of the outer codeword with an inner code; and indicate the outer code and the outer code rate through signaling, including setting a first value for a first field of a control channel, the first value determined by the outer code and a reference code rate, and signaling a difference between the outer code rate and the reference code rate using first overhead information symbols describing the logical channel, wherein the outer code rate is updatable on a superframe basis.

Implementations of such a product may include one or more of the following features. The instructions can be further configured to cause the processor to indicate the difference between the outer code rate and the reference code rate using second overhead information symbols embedded in the logical channel. The outer code can be a Raptor code. The instructions can be further configured to cause the processor to determine the outer code rate at least in part by the multiple data link layer packets of the logical channel.

An example of a computer program product includes a processor-readable medium storing processor-readable instructions configured to cause a processor to: receive data to be communicated to a device by transmission on a communication link of a content delivery system, the data received as a multiple data link layer packets of a logical channel carrying broadcast data; encode the multiple data link layer packets of the logical channel as one outer codeword using an outer code at an outer code rate; encode symbols of the outer codeword with an inner code; and indicate the outer code and the outer code rate through signaling, including signaling the outer code rate using overhead information symbols describing the logical channel, wherein the outer code rate is updatable on a superframe basis.

Implementations of such a product may include one or more of the following features. The outer code can be a Raptor code. The instructions can be further configured to cause the processor to determine the outer code rate at least in part by the multiple data link layer packets of the logical channel.

An example of a computer program product includes a processor-readable medium storing processor-readable instructions configured to cause a processor to: receive data transmitted on a communication link; inner decode the received data with an inner code; and outer decode output of the inner decoding as one outer codeword using a Raptor code at an outer code rate, wherein the inner decoding is based on first extrinsic information produced by the outer decoding, and the outer decoding is based on second extrinsic information produced by the inner decoding.

An example of a computer program product includes a processor-readable medium storing processor-readable instructions configured to cause a processor to: receive data to be communicated over a multiple superframes to a device by transmission on a communication link, the data received as a multiple data link layer packets of a logical channel; encode the multiple data link layer packets of the logical channel as one outer codeword using an outer code at an outer code rate; encode symbols of the outer codeword with an inner code; and indicate the outer code, the outer code rate, and the multiple superframes of which the data are jointly encoded as the outer codeword using the outer code.

Implementations of such a product may include the feature where the communication link can be part of a content delivery system; and the outer code can be a Raptor code.

An example of an apparatus configured to encode data for transmission on a communication link of a content delivery system includes: means for receiving data to be communicated to a device, the data received as a multiple data link layer packets of a logical channel carrying broadcast data; means for encoding the multiple data link layer packets of the logical channel as one outer codeword using an outer code at an outer code rate; means for encoding symbols of the outer codeword with an inner code; and means for indicating the outer code and the outer code rate through signaling, including setting a first value for a first field of a control channel and setting a second value for a second field of the control channel, wherein the first value is determined by the outer code, and the second value is determined by the outer code rate.

Implementations of such an apparatus may include one or more of the following features. The outer code can be a Raptor code. The apparatus can further include means for determining the outer code rate at least in part by the multiple data link layer packets of the logical channel.

An example of an apparatus configured to encode data for transmission on a communication link of a content delivery system includes: means for receiving data to be communicated to a device, the data received as a multiple data link layer packets of a logical channel carrying broadcast data; means for encoding the multiple data link layer packets of the logical channel as one outer codeword using an outer code at an outer code rate; means for encoding symbols of the outer codeword with an inner code; and means for indicating the outer code and the outer code rate through signaling, including setting a first value for a first field of a control channel, the first value determined by the outer code and a reference code rate, and signaling a difference between the outer code rate and the reference code rate using first overhead information symbols describing the logical channel, wherein the outer code rate is updatable on a superframe basis.

Implementations of such an apparatus may include one or more of the following features. The apparatus can further include means for indicating the difference between the outer code rate and the reference code rate using second overhead information symbols embedded in the logical channel. The outer code can be a Raptor code. The apparatus can further include means for determining the outer code rate at least in part by the multiple data link layer packets of the logical channel.

An example of an apparatus configured to encode data for transmission on a communication link of a content delivery system includes: means for receiving data to be communicated to a device, the data received as a multiple data link layer packets of a logical channel carrying broadcast data; means for encoding the multiple data link layer packets of the logical channel as one outer codeword using an outer code at an outer code rate; means for encoding symbols of the outer codeword with an inner code; and means for indicating the outer code and the outer code rate through signaling, including signaling the outer code rate using overhead information symbols describing the logical channel, wherein the outer code rate is updatable on a superframe basis.

Implementations of such an apparatus may include one or more of the following features. The outer code can be a Raptor code. The apparatus can further include means for determining the outer code rate at least in part by the multiple data link layer packets of the logical channel.

An example of an apparatus configured to decode data transmitted on a communication link of a content delivery system includes: means for receiving data transmitted on the communication link; means for inner decoding the received data with an inner code; and means for outer decoding output of the inner decoding as one outer codeword using a Raptor code at an outer code rate, wherein the inner decoding is based on first extrinsic information produced by the outer decoding, and the outer decoding is based on second extrinsic information produced by the inner decoding.

An example of an apparatus configured to encode data for transmission on a communication link includes: means for receiving data to be communicated over multiple superframes to a device, the data received as multiple data link layer packets of a logical channel; means for encoding the multiple data link layer packets of the logical channel as one outer codeword using an outer code at an outer code rate; means for encoding symbols of the outer codeword with an inner code; and means for indicating the outer code, the outer code rate, and the multiple superframes of which the data are jointly encoded as the outer codeword using the outer code.

Implementations of such an apparatus may include the feature where the communication link can be part of a content delivery system; and the outer code can be a Raptor code.

Items and/or techniques described herein may provide one or more of the following capabilities. Using a new code as an outer code in concatenated coding schemes of content delivery systems provides longer codewords by encoding an entire logical channel as one code block. The new outer code has a longer codeword, formed of physical layer packets, and thus can provide protection for a larger set of error patterns. Instead of adding “stuffing” packets, additional repair packets can be generated and sent to improve error correction at a receiving device. In some implementations, proposed signaling allows for defining a larger number of code rates for the outer code, providing finer granularity to ensure a desired decoding error probability or to adapt to the priority of content, for example. In some implementations, the outer code rate of a logical channel can dynamically change from superframe to superframe. In some other implementations, data to be transmitted across multiple superframes can be jointly encoded by the new outer code, leading to even longer codewords that can provide further time diversity. While item/technique-effect pairs have been described, it may be possible for a noted effect to be achieved by means other than those noted, and a noted item/technique may not necessarily yield the noted effect.

### BRIEF DESCRIPTION OF THE DRAWINGS

FIG. 1 illustrates an exemplary mobile broadcast system.

FIG. 2 illustrates an exemplary MediaFLO™ system logical architecture.

FIG. 3 diagrammatically illustrates a conventional coding/decoding scheme for use in a communication system.

FIG. 4 illustrates a Reed-Solomon error control block structure.

FIG. 5 diagrammatically illustrates a coding/decoding scheme for use in a communication system.

FIG. 6 illustrates an outer error control block structure.

FIG. 7 illustrates the sequencing of packets of an outer error control block in a superframe.

FIG. 8 illustrates an outer error control block structure for jointly encoding data of multiple superframes.

FIG. 9 illustrates the sequencing of packets of an outer error control block across multiple superframes.

FIG. 10 is a block flow diagram of a process of encoding data for transmission on a communication link.

FIG. 11 is a block flow diagram of another process of encoding data for transmission on a communication link.

FIG. 12 is a block flow diagram of yet another process of encoding data for transmission on a communication link.

FIG. 13 is a block flow diagram of a process of decoding data transmitted on a communication link.

FIG. 14 is a block flow diagram of still another process of encoding data for transmission on a communication link.

In the figures, components with similar relevant characteristics and/or features may have the same reference label.

### DETAILED DESCRIPTION

Techniques described herein provide mechanisms for encoding data for transmission on a communication link. Data is received for communicating to a device, where the data is received as multiple data link layer packets of a logical channel. These data link layer packets are referred to as data link layer source packets. The multiple data link layer packets are encoded as one outer codeword using an outer code of an outer code rate to generate data link layer repair packets. The symbols of the outer codeword, as data link layer source and repair packets, are further encoded with an inner code. The outer code and the outer code rate are indicated through signaling. In some implementations, the outer code rate is indicated using field values of a control channel or overhead information symbols. In some other implementations, a reference outer code rate is indicated by a control channel, while a difference between the outer code rate and the reference outer code rate is indicated in overhead information symbols describing the logical channel. In some implementations, the outer code rate of a logical channel can dynamically change from superframe to superframe. In some implementations, data to be communicated over multiple superframes is jointly encoded as a single outer codeword using an outer code. Techniques are also provided for decoding data transmitted on a communication link. Other implementations are within the scope of the disclosure and claims.

### Mobile Broadcast System

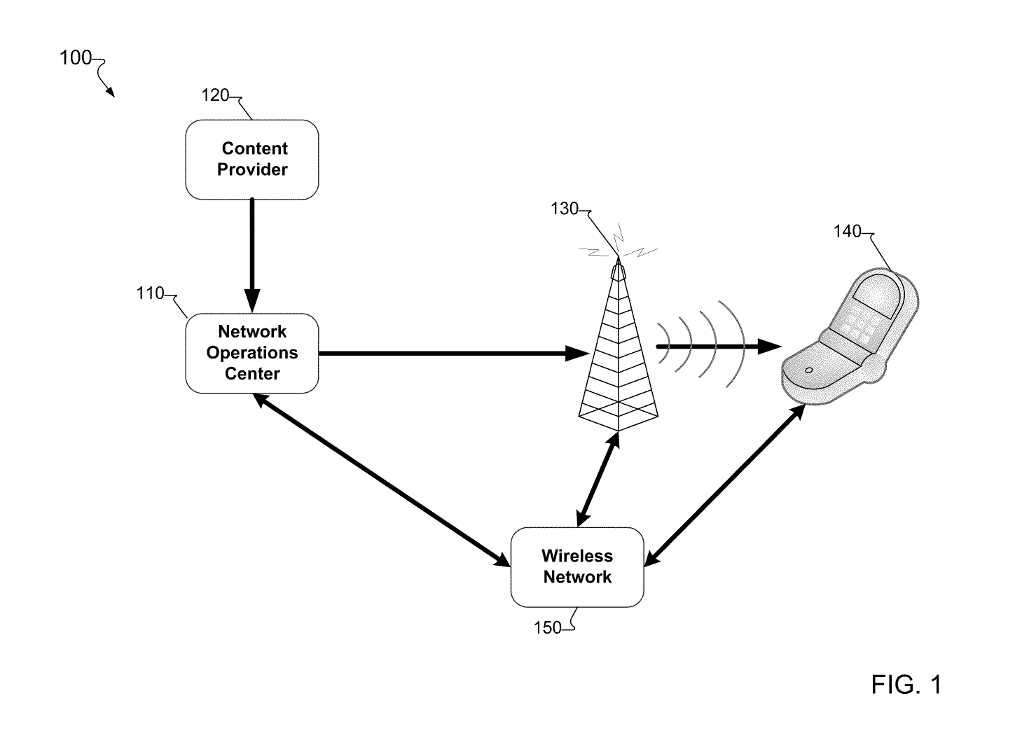

FIG. 1 illustrates an exemplary mobile broadcast system 100. The mobile broadcast system operates in accordance with the standards published by the FLO forum, and in particular is typified by the MediaFLO™ broadcast system by QUALCOMM Incorporated of San Diego, Calif. Using a cellular standard, such as GSM or CDMA, enables MediaFLO™ to provide security and services utilizing unicasting associated with a wireless paradigm. The MediaFLO™ mobile broadcast platform delivers content across a mobile environment. MediaFLO™ utilizes a combination of broadcast and wireless paradigms to provide business opportunities within a mobile broadcast ecosystem. Using the Forward Link Only (FLO) air interface standard, MediaFLO™ provides greater content capacity and reduced content delivery costs associated with broadcasting paradigms.

MediaFLO™, or FLO™, technology is designed to meet the mobile entertainment requirements of end users and service providers, by, for example, providing television services to end users and features designed to facilitate monetization by service providers. MediaFLO™ provides a broad range of content to mobile devices in a spectrally efficient, cost-effective and designed for low power consumption system. For example, the MediaFLO™ system can deliver streaming television, video and audio, Clipcast™ video and audio, and real-time Internet Protocol (IP) data services to MediaFLO™ compatible mobile devices. The mobile devices can selectively receive, display, play, store, and manipulate the content delivered over the mobile broadcast system 100. Devices usable with the MediaFLO™ system include smartphones, cellular phones, personal digital assistants (PDA), interactive game devices, notebooks, smartbooks, netbooks, data processing apparatus, or other such electronic devices.

MediaFLO™ also can be configured to group programming into one or more subscription packages. Users, or subscribers, operating MediaFLO™ compatible mobile devices can select one or more of the MediaFLO™ subscription packages. For example, reception and decoding of channels included in a MediaFLO™ subscription package can be enabled in response to user input, e.g., touching a touchscreen on a MediaFLO™ compatible mobile device. Any number of conditional access solutions (CAS) can be utilized for controlling access to MediaFLO™ content and services. Additionally, the mobile broadcast system 100 can maintain quality by providing service flexibility with variable bit rate encoding. Variable bit rate encoding balances bandwidth, which is important to the service operator, with high-quality audio and video, which makes the end user experience more enjoyable.

MediaFLO™ end user services can include real-time content delivery, such as video and audio presentations, audio only programming and audio with slides programming. In some implementations, the real-time services can include enhanced H.264 video and AAC+ audio formats. End user services also can include non-real-time content delivery, such as network scheduled delivery of audio clips, e.g., MP4, and multimedia files, e.g., JPEG, PNG, and HTML. Non-real-time services generally comprise the mobile device capturing specific pieces of multimedia and other data for presentation at a later time. For example, a non-real-time service called “clipcasting” provides network scheduled delivery of data services and files, such as wallpaper or e-coupons, for capture by a mobile device. Additionally, Clipcast can be implemented to deliver multimedia clips with multi-presentation views, e.g., from a plurality of perspectives, to a mobile device in accordance with a network schedule.

The mobile broadcast system 100 also can enable audio and video clips, or multimedia clips, to be stored at the MediaFLO™ compatible mobile device in internal memory, external memory, or both. End users can view, listen, and play any stored clip that has not expired. In some implementations, the mobile device can include a file cache size that is configurable by the service operator, the end user, or both.

Additionally, MediaFLO™ can offer end user IP data services, such as FLO network delivery of Internet traffic to third-party applications. Third-party mobile applications can provide end users with dynamic home pages, that include, e.g., stock, news, weather and sports information. For example, the delivery of IP data services can enable stock tickers to be tailored to a user's specific profile. Additionally, MediaFLO™ can be integrated with two-way data exchange applications, such as text and voice chat, live voting, email and web browsing, video-on-demand and shopping, in addition to other interactive mobile application features. With such interactivity, a user can obtain additional information associated with the real-time or non-real-time programming. For example, a dinner recipe may be downloaded during the broadcast of a cooking show and shared with a user's friends, e.g., via a SMS message.

Referring once again to FIG. 1, the mobile broadcast system 100 generally comprises multiple nodes 110-140 that communicate, for example, over a wireless network 150. The wireless network 150, also referred to as a “wireless communication system,” encompasses both the physical network as well as digital signal technology. The wireless network 150 can be implemented as: a code division multiple access (CDMA) system; a frequency division multiple access (FDMA) system; a time division multiple access (TDMA) system such as Global System for Mobile communications (GSM), GSM/General Packet Radio Service (GPRS), Enhanced Data GSM Environment (EDGE) or Terrestrial Trunked Radio (TETRA); a Wideband CDMA (WCDMA) system; Evolution Data Optimized (EV-DO) systems such as 1xEV-DO, EV-DO Rev A or EV-DO Rev B; High Speed Packet Access (HSPA) systems such as High Speed Downlink Packet Access (HSDPA), High Speed Uplink Packet Access (HSUPA) or Evolved High Speed Packet Access (HSPA+); a Long Term Evolution (LTE) system; or other communications systems, such as a system utilizing 3G or 4G technology. Content distributed over the interconnected nodes 110-140 can be selectively received, transmitted, processed, stored, and displayed.

The nodes of the mobile broadcast system 100 generally comprise a network operations center 110, one or more content providers 120, one or more FLO transmitters 130, and a plurality of mobile devices 140. The network operations center 110 can include one or more receivers (not shown) configured to receive content from one or more content providers 120. In some implementations, the receivers can reside at the network operations center 110. For example, the network operations center 110 can include a C-band receiver configured to receive content delivered by a C-band satellite content provider 120. In other implementations, the receivers can be located remotely from the network operations center 110 and can deliver the received content to the network operations center 110 using wired or wireless technology. The content received from the one or more content providers 120 can include local and national content. The local and national content can include real-time, non-real-time and IP data services content.

The real-time content can be received from C-band and Ku-band satellites, terrestrial broadcast transmitters, and data networks, in addition to other such transmitting devices and networks. The real-time content can include video, such as MPEG-2 over asynchronous serial interface, or YUV over serial digital interface. The real-time content also can include audio, such as AC-3 or MP2 over ASI, as well as PCM over SDI. Additionally, real-time content formatted in NTSC and PAL technologies can be delivered to the network operations center 110. Real-time MediaFLO™ content and services can be implemented to bring television experiences, similar to those experienced on a traditional television, to a mobile device. For example, the television experiences can include general entertainment programming, such as live sporting events, news, music concerts, and weather updates.

Similarly, non-real-time content formatted in MPV, such as MPEG-4 audio and video clips, and data services via Clipcast (DSvC), such as JPEG, PNG and HTML files, also can be received at the network operations center 110. The network operations center 110 can process the non-real-time content and can schedule network delivery of the content to one or more mobile devices. MediaFLO™'s non-real-time content and file delivery can extend the user experience to include short clips, e.g., YouTube™ videos, and files of non-real-time content, e.g., stored audio files.

In addition, MediaFLO™ can be implemented to deliver IP data services content, such as stock tickers, weather and news updates to the network operations center 110. The IP data services content can include a broad range of information accessible to each MediaFLO™ subscriber. In some implementations, the IP data services content can be tailored to a user's specific profile. For example, a MediaFLO™ subscriber can choose to receive particular IP data services content, such as weather and sports scores, at their MediaFLO™ compatible mobile device. Both the non-real-time and IP data services content can be delivered to the network operations center 110 over one or more data networks.

In some implementations, the network operations center 110 can aggregate the content received from the one or more content providers 120. In some implementations, the network operations center 110 can include additional content, such as locally stored content in the multiplexed content data stream. The aggregated content can be multiplexed at the network operations center 110 and distributed as a content data stream to one or more FLO transmitters 130. The one or more FLO transmitters 130 can receive the multiplexed content data stream from the network operations center 110. Based on the multiplexed content data stream, the FLO transmitters 130 can generate one or more FLO waveforms. The one or more FLO waveforms can be transmitted to one or more mobile devices 140.

Text, graphical and video content received from the FLO transmitters 130 can be displayed on a display screen at the mobile device 140. Audio content received from the FLO transmitters 130 can be played back at one or more audio outputs at the mobile device 140. The mobile device 140 can include an external and internal memory module that can store the received content. In some implementations, the mobile device 140 can communicate with the network operations center 110 over a reverse link, such as the wireless network 150. The reverse links can be used to communicate information for mobile device 140 activations, service key distribution, subscriptions, and usage tracking

### MediaFLO™ System Logical Architecture

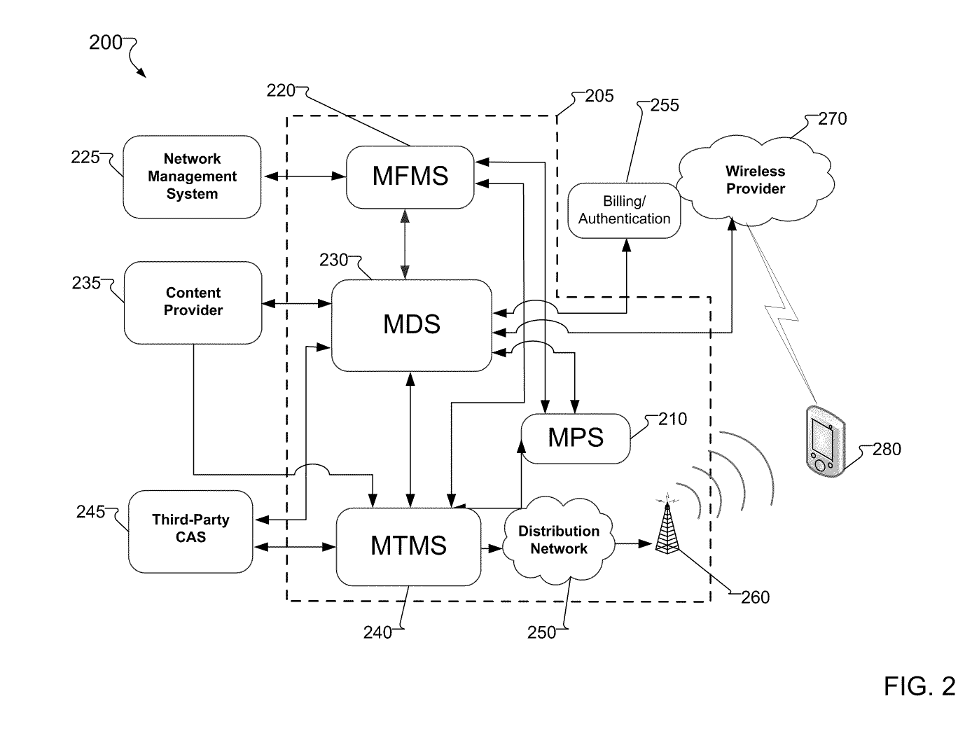

FIG. 2 illustrates an exemplary MediaFLO™ system logical architecture 200. The MediaFLO™ system logical architecture 200 includes one or more systems, subsystems, and components, a subset of which constitute a MediaFLO™ network 205. The MediaFLO™ network 205 generally comprises a MediaFLO™ Provisioning System (MPS) 210, a MediaFLO™ Management System (MFMS) 220, a MediaFLO™ Distribution System (MDS) 230, and a MediaFLO™ Transcode and Multiplex System (MTMS) 240. The MediaFLO™ network 205 may be implemented in the network operations center 110 depicted in FIG. 1. The MediaFLO™ network 205 also includes a FLO Radio Access Network (RAN) subsystem, comprising the MTMS 240, a distribution network 250 and one or more FLO transmitters 260. The MediaFLO™ network 205 can be implemented to deliver real-time, non-real-time and IP data services content to one or more mobile devices, such as a MediaFLO™ device 280.

The MPS 210 provides one or more interfaces for an operator to configure the MediaFLO™ network 205. The MPS 210 distributes the MediaFLO™ network 205 configuration to the various systems, subsystems, and components included in the MediaFLO™ network 205. In some implementations, the MPS 210 can provide one or more web services programming interfaces. Web and software developers can generate custom web services applications through the web service programming interface. For example, a MediaFLO™ developer using the MPS 210 programming interface can generate and offer custom subscription packages to MediaFLO™ subscribers. In addition, the MPS 210 can share data and information, i.e., transmit to and receive from, with the MFMS 220, the MDS 230, and MTMS 240.

The MFMS 220 performs the operations, administration and maintenance functions for the MediaFLO™ network 205. Specifically, the MFMS 220 can monitor the systems constituting the MediaFLO™ service platform, i.e., the MPS 210, the MDS 230, and the MTMS 240. Components outside the MediaFLO™ service platform can be monitored by other systems, subsystems, or components. The MFMS 220 can provide management interfaces to enable network, state, fault, security, performance, and log management within the MediaFLO™ network 205. Network management can include discovering new networks and nodes to monitor, deleting monitored nodes, controlling MediaFLO™ agents and components, such as reset counters, restarting components, and terminating components. For example, the MFMS 220 network management interface can be used to communicate with and control the network management system 225. The network management system 225 can be implemented to manage the MediaFLO™ network 205 within, or external to, the MediaFLO™ network 205.

State management can include monitoring the high availability state of MediaFLO™ components, managing the administrative state of MediaFLO™ components, and monitoring the operational state of MediaFLO™ components. Fault management can include managing events, alarms and alarm maps, as well as performing fault recovery. For example, a network operator can clear one or more alarms using a client interface associated with the fault management server component of the MFMS 220. Security management can include controlling operator access to the element management system and fault management system. Performance and log management can include collecting statistics from MediaFLO™ components, providing threshold-based monitoring, and providing reports and graphical views for the Key Performance Indicators (KPI) generated from the statistics. KPIs can be derived from the statistics and can define and measure progress toward organizational goals. In addition, the MFMS 220 can share data and information with the MDS 230 and the MTMS 240.

The MDS 230 provides efficient distribution of encrypted content across one or more wireless networks. The wireless networks can include data optimized (DO) networks, DO-multicast networks, 3G or 4G networks and FLO networks. The MDS 230 can maintain responsibility for aggregation and distribution of real-time content, non-real-time content, IP data services content, subscription services management and FLO resource scheduling. Additionally, the MDS 230 can be implemented to perform configuration management for the MediaFLO™ network 205. The MDS 230 also can include one or more of the following subsystems: distribution; digital rights management (DRM); subscription, billing and service management; unicast request handling; and usage tracking

The MDS 230 distribution subsystem interfaces with one or more content providers 235 to receive real-time, non-real-time, and IP data services content from the one or more content providers 235. The MDS 230 functions to provide a single user interface for streaming, Clipcast, and IP data services content. In some implementations, the MDS 230 distribution subsystem manages files, clips, and data content delivery. The distribution subsystem may also receive and consolidate program guide data from the content provider 235 and other sources, e.g., Tribune Media Services. The consolidated guide is termed a MediaFLO™ Program Guide (MPG) and can be implemented as an easy to use guide that contains program description and file delivery information associated with MediaFLO™ end users. The MDS 230 distributes the content, the MPG, and subscription information to one or more mobile devices using a FLO transmitter 260 or via a wireless provider 270.

The MDS 230 also can generate system information, such as overhead information, and can initiate distribution of the overhead information. In addition, the distribution subsystem can receive Clipcast content from content providers and can schedule clip delivery to mobile devices, such as a MediaFLO™ device 280, during contact windows. The distribution subsystem also can encrypt content for conditional access and apply forward-error-correction (FEC) encoding to improve reception probability at the MediaFLO™ device 280. Additionally, the distribution subsystem can be implemented to deliver content based on a network, or content provider, delivery schedule.

The MDS 230 DRM subsystem can distribute encryption keys to MediaFLO™ network 205 components. In addition, the DRM subsystem can securely distribute decryption keys to one or more MediaFLO™ devices 280. The DRM subsystem also can synchronize with one or more the third-party CAS 245. Third-party CAS 245 can provide protection of services on a per-user basis. For example, a third-party CAS 245 can blackout specific programs in certain regions, or restrict content available to a particular market.

The MDS 230 subscription, billing and service management (SBSM) subsystem can be implemented to make subscription-based billing predictable and readily understood. The SBSM subsystem can manage and provide MediaFLO™ content package subscriptions. For example, the SBSM subsystem can provide subscription services and a back-end billing interface 255 for the MediaFLO™ network 205. The back-end billing interface 255 can include billing and authentication information, in addition to authorization and accounting functions. Additionally, the SBSM subsystem can provide MediaFLO™ service management and can generate new and custom subscription packages. The SBSM subsystem can receive subscription information from one or more mobile devices. In some implementations, the SBSM subsystem can activate MediaFLO™ services for one or more subscribing mobile devices.

The MDS 230 unicast request handling subsystem can be implemented to manage functions related to unicast device-to-server interface protocols. The unicast request handling subsystem includes a unicast configuration server (UCS) and a usage tracking service request handler (UTSRH). The UCS can receive provisioned application upgrade information sent from the MPS 210. In some implementations, the MPS 210 maintains all application version information, whereas the UCS only maintains the latest application version information. The MediaFLO™ device 280 generally receives application upgrade notifications via, e.g., a multicast notification delivery path from the wireless provider 270. However, when the MediaFLO™ device 280 application version is out-of-date, the MediaFLO™ device 280 can perform an application upgrade check via a unicast connection to the UCS to obtain the latest version information. The UTSRH can collect service usage and performance statistics from MediaFLO™-enabled mobile devices. For example, the MediaFLO™ device 280 can be instructed to log usage events and upload the logged usage tracking statistics to the UTSRH. The UTSRH can collect the usage tracking statistics from the MediaFLO™ device 280 and can forward the usage tracking log to the usage tracking subsystem. In some implementations, usage tracking parameters can be transmitted to the MediaFLO™ device 280 as part of the notification flow. The MediaFLO™ device 280 can decide what events to log and when to log the usage tracking statistics based on the usage tracking parameters.

The MDS 230 usage tracking subsystem can receive the MediaFLO™ device's 280 upload data from the UTSRH and can log the data in persistent storage. In some implementations, the usage tracking subsystem can collect upload data directly from the one or more MediaFLO™-enabled mobile devices. The usage tracking subsystem can be implemented to share at least a portion of the usage tracking statistics with one or more third-party entities. In some implementations, the third-party entities can use the usage tracking statistics to measure MediaFLO™ users' service usage patterns. In addition, the MDS 230 can share data and information with the MTMS 240.

The MTMS 240 can be implemented to receive content from one or more content providers 235. The content can include real-time, non-real-time and IP data services content. The MTMS 240 can aggregate the received content and can change the content into a format supported by one or more mobile devices. In some implementations, the MTMS 240 can encode the content received from the one or more content providers 235. For example, real-time, non-real-time and IP data services content can be aggregated and transcoded at the MTMS 240 for delivery to the MediaFLO™ device 280. The MTMS 240 also can multiplex the received content before delivering encoded and multiplexed content to a distribution network 250. In some implementations, a multiplexer component of the MTMS 240 can aggregate the received content and alter the content into a MediaFLO™ supported format. Additionally, in some implementations, the multiplexer component can include a statistical multiplexer (Stat-MUX) that can be configured to change the bit rate of services according to the needs of different channels at different times. In statistical multiplexing, a communication channel can be divided into an arbitrary number of variable bit rate digital channels or data streams. The Stat-MUX can employ a more complex method of managing change in input channel bit rates, which can result in a better utilization of bandwidth. For example, using the Stat-MUX, a MediaFLO™ network 205 operator can decrease the bit rate for generally static channel programming, like a newscast, while increasing the bit rate for more dynamic channel programming, like a basketball game. The MTMS 240 also can be implemented to encrypt content, in addition to determining resource allocation and distribution of content. Moreover, the MTMS 240 can communicate with one or more third-party CAS 245. In addition, the MTMS 240 can transmit data and information through the distribution network 250 to the FLO transmitter 260.

The distribution network 250 can receive encoded content from the MTMS 240 and can distribute the content to the one or more FLO transmitters 260. The FLO transmitter 260 can receive encoded content from the MTMS 240 over the distribution network 250. The encoded content can include content belonging to a wide-area operational infrastructure (WOI) and a local-area operational infrastructure (LOI). Generally, the WOI content is associated with a wide-area broadcast signal that will be transmitted over a larger broadcast area than the LOI content, which is associated with a local-area broadcast signal. For example, the WOI content may be national news, and the LOI content may be regional or local news. The WOI and LOI content can be received by the FLO transmitter 260 in distinct WOI and LOI signals, or in one or more combined signals. The FLO transmitter 260 can be implemented to transmit the WOI content, the LOI content, or both, as a mobile broadcast signal to one or more mobile devices. The FLO transmitter 260 can supply the content to MediaFLO™-enabled mobile devices by transmitting a FLO waveform. For example, the FLO transmitter 260 can transmit a FLO waveform including the WOI and LOI content to the MediaFLO™ device 280.

In some implementations, the FLO transmitter 260 also can transmit content particular to a specific venue, or micro-venue. The content particular to the specific venue or micro-venue can be received from the MTMS 240 over the distribution network 250. Venues can include, e.g., sporting arenas, concert halls, movie theatres, shopping malls, or other such event locations. For example, the FLO transmitter 260 can transmit player statistics associated with a baseball game to MediaFLO™-enabled mobile devices residing within the confines, or surrounding area, of a baseball stadium. Micro-venues can include, e.g., office buildings, automobiles or other mobile objects, restaurants, shopping mall department stores or kiosks, or other more localized event locations. For example, the FLO transmitter 260 can transmit sale-related data to users operating MediaFLO™-enabled mobile devices within the confines, or surrounding area, of a department store. Additional information related to venue and micro-venue broadcasting can be found in U.S. patent application Ser. No. 12/569,792, filed Sep. 29, 2009, entitled “Apparatus and Methods of Providing and Receiving Venue Level Transmissions and Services,” the entire contents of which are incorporated by reference herein.

The FLO transmitter 260 can include an exciter component and a transmitter component. The exciter component can receive ASI MPEG-2 transport streams and can perform proportional-integral-derivative (PID) filtering for the desired multiplex. The exciter component also can generate low power, e.g., less than 1-watt, FLO waveforms for the transmitter input. The transmitter component can generate RF signals that can be received over an air interface by one or more mobile devices. In some implementations, the transmitter can generate and transmit a FLO waveform using orthogonal frequency division multiplexing (OFDM). The transmitter also can be implemented to deliver RF signals to the MediaFLO™ device 280 via broadcast, multicast and unicast methodologies.

In some implementations, the MTMS 240, the distribution network 250 and the FLO transmitter 260 comprise the FLO RAN subsystem. The FLO RAN subsystem can receive real-time, non-real-time and IP data services content, and can perform audio and video encoding. The FLO RAN subsystem also can multiplex the received content and can distribute the multiplexed data streams. For example, the FLO RAN subsystem can receive real-time content, encode it, and multiplex it with other services, e.g., IP data services or DSvC, before encapsulating and distributing the content to FLO transmitters 260. Additionally, the FLO RAN subsystem can transmit one or more FLO waveforms to one or more mobile devices. For example, the FLO transmitter 260 of the FLO RAN subsystem can transmit one or more FLO signals to the MediaFLO™ device 280. The MediaFLO™ device 280 can be implemented to demodulate the FLO RF signal. Users operating the MediaFLO™ device 280 can navigate through each of the MediaFLO™ supported services and can access content received at the device. In addition, MediaFLO™ device 280 users can perform transaction-oriented operations with the MDS 230 over unicast connections through the wireless provider 270.

### Conventional Concatenated Coding Structure

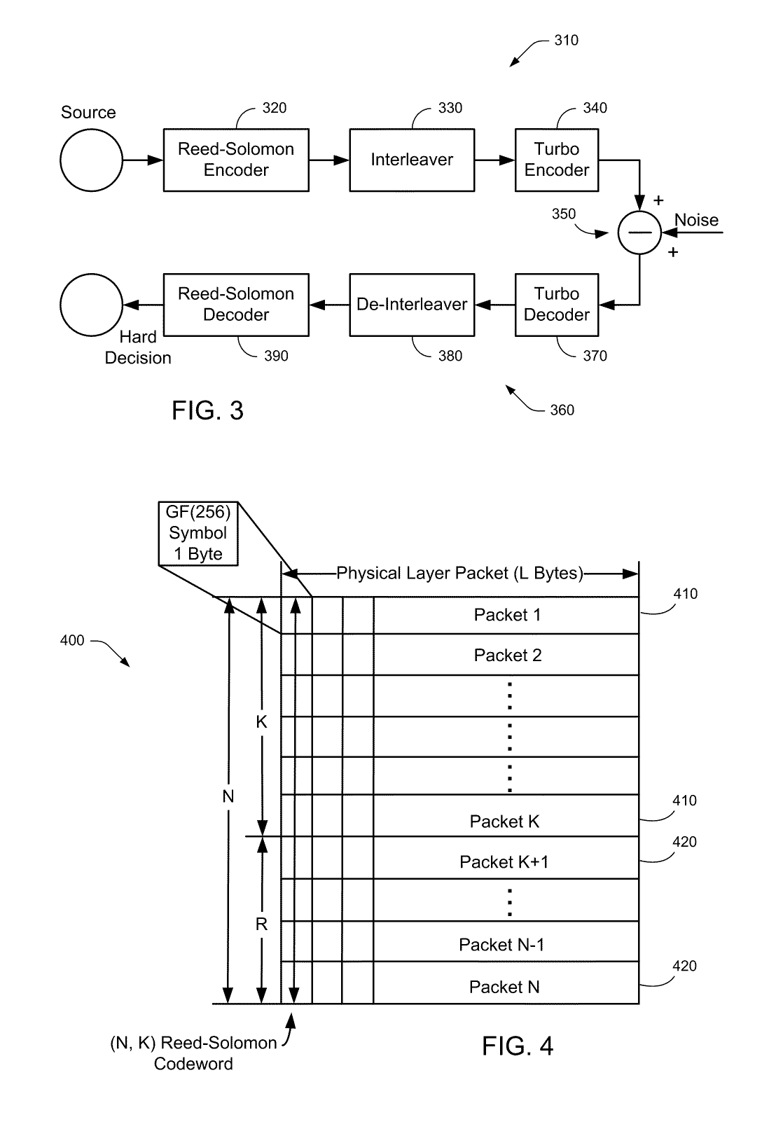

FIG. 3 diagrammatically illustrates a conventional coding/decoding scheme for use in a communication system. The arrangement of FIG. 3 uses a concatenated coding structure with turbo coding for an inner code and Reed-Solomon coding for an outer code. At the transmitter, designated generally at 310, K data source packets are input to an outer Reed-Solomon encoder 320. The Reed-Solomon encoder 320 receives the block of K input packets and encodes parities to create (N−K) parity packets. The packets output by the Reed-Solomon encoder 320 are byte-level interleaved at an interleaver 330, and then encoded through an inner turbo encoder 340. The turbo encoded packets produced by the turbo encoder 340 are bit-level interleaved and modulated (not shown), and then transmitted through a noisy communication channel shown diagrammatically at 350. The receiver, designated generally at 360, implements the appropriate demodulation and bit-level de-interleaving (not shown), and includes a turbo decoder 370 that generates log likelihood ratios (LLRs) that respectively correspond to the turbo coded bits that arrive at the turbo decoder 370. The turbo decoder 370 updates the LLR values iteratively until a cyclic redundancy check (CRC) is satisfied or a maximum number of iterations is reached. Hard decisions regarding the bits of successfully decoded packets are de-interleaved at a de-interleaver 380. A Reed-Solomon erasure decoder 390 performs erasure decoding to recover the erased packets if possible. The decoded packets are then passed from the Reed-Solomon decoder 390 to an upper layer (not shown). Descriptions of the type of coding/decoding scheme shown in FIG. 3 are provided by “Chari” and references therein.

If (N, K) is the dimension of the Reed-Solomon code being used at the symbol level (in bytes), then the Reed-Solomon code rate is R_{RS}=K/N. Some conventional systems support multiple code rates so, for example, K=8, 12, 14, or 15 can be used. For example, for the MediaFLO™ broadcast system, Reed-Solomon outer coding is specified for encoding rates R_{RS} of ⅞, ¾, and ½ for N=16 byte-sized symbols.

The encoding operation of an (N, K) Reed-Solomon code in the aforementioned concatenated coding system (320 in FIG. 3) is illustrated in FIG. 4. Each row in the Reed-Solomon error control block 400 of FIG. 4 will form the payload for a physical layer packet, and each column contains one byte from each of the packets. The first K packets from the top can be systematic packets 410 from the source (see also FIG. 3). The Reed-Solomon encoder acts along each column of data, i.e., processes the K systematic bytes in a column and adds (N−K) parity bytes per column. Thus, for an (N, K) Reed-Solomon code, there would be the payload for N physical layer packets (i.e., corresponding to K systematic packets 410 and (N−K) parity packets 420) as a code block at the output of the Reed-Solomon encoder 320 of FIG. 3. The column-wise operation of the Reed-Solomon encoder 320 constitutes an implicit byte interleaving (e.g., the byte-level interleaving at the interleaver 330 in FIG. 3).

For the MediaFLO™ broadcast system, the packets received at the input to the Reed-Solomon encoder 320 are Media Access Control (MAC) layer source packets. For an (N, K) Reed-Solomon code, MAC layer “stuffing” packets are added, as needed, so that the total number of MAC layer source and stuffing packets in a MAC layer capsule contained in one MLC (i.e., the MLC data to be communicated over a superframe) is a multiple of K.

In MediaFLO™, a video or audio stream can be sent in two layers, i.e., a base layer that enjoys reception over a wide area and an enhancement layer that improves the audio-visual experience provided by the base layer over a more limited coverage area. Descriptions of the base and enhancement layers are provided by “Chari” and references therein. If the base component MAC layer capsule length is not an integer multiple of K, the MAC layer stuffing packets are placed ahead of the payload of the base component in the MAC layer capsule. Corresponding MAC layer stuffing packets are also added to the enhancement component MAC layer capsule, if present, and placed ahead of the payload of the enhancement component in the MAC layer capsule.

In MediaFLO™, when an MLC containing multiple Reed-Solomon error control blocks 400 needs to be transmitted in a superframe, a sub-block of size N/4 packets from each Reed-Solomon error control block 400 is sent in each of four frames in the superframe, with all of the sub-blocks assigned to a frame transmitted contiguously. Descriptions of the algorithm for sequencing of packets of Reed-Solomon error control blocks 400 in a superframe are provided by “Chari” and references therein.

### Concatenated Inner/Outer Coding Structure for Encoding Long Codewords

Techniques are now described for encoding multiple packets of a logical channel to be communicated over a superframe as a single long outer codeword using an outer code of a concatenated inner/outer coding scheme. The described techniques can result in an outer codeword and an outer error control block spanning an entire logical channel capsule. Greater time diversity and improved coding performance are possible due to the longer codewords generated.

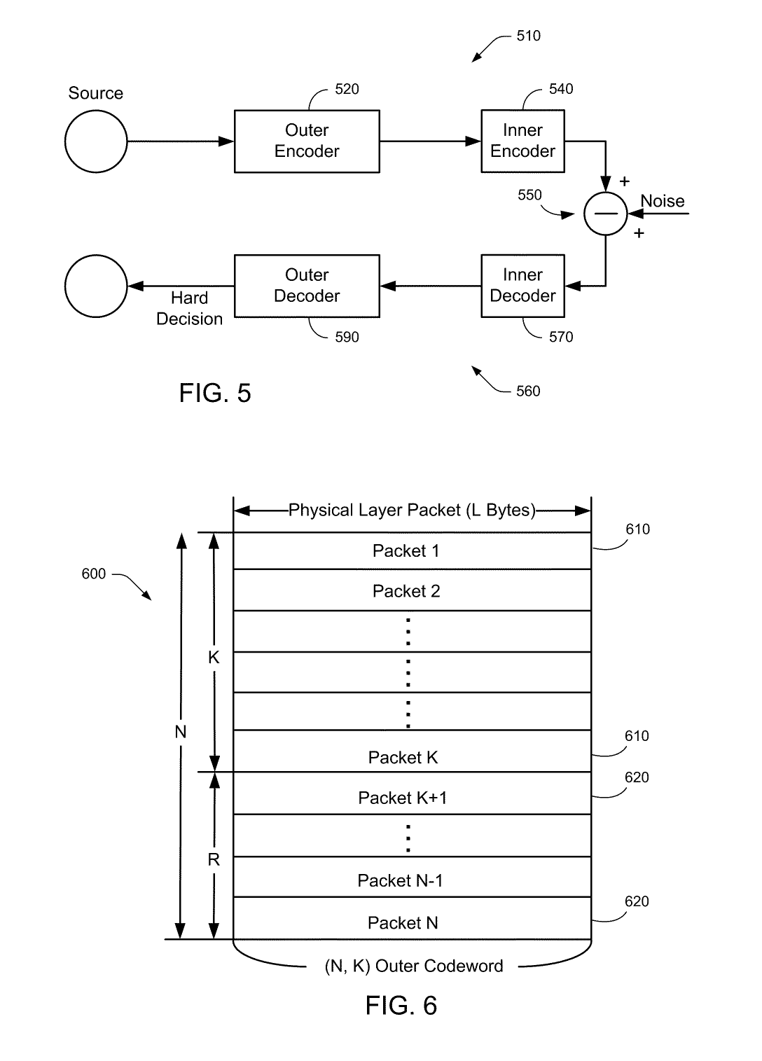

FIG. 5 diagrammatically illustrates a coding/decoding scheme for use in a communication system, e.g., a content delivery system. The arrangement of FIG. 5 uses a concatenated coding structure with an inner code (e.g., a turbo code, a convolutional code, or a low-density parity-check code) and an outer code (e.g., a chain reaction code). Chain reaction codes, including Luby Transform (LT™) chain reaction codes and Raptor™ multi-stage chain reaction (“MSCR”) codes, provide excellent recovery of lost packets, and are highly adaptable to varying channel conditions.

In this disclosure, systematic Raptor™ codes are generally considered for the outer code in concatenated coding schemes for content delivery services, although other types of codes can be used in the alternative. Raptor™ codes have been standardized for FEC protection in systems for Digital Video Broadcast (DVB) and Multimedia Broadcast and Multicast Services (MBMS). Raptor™ codes are a computationally efficient implementation of fountain codes that achieve very close to ideal performance (i.e., no additional repair data is required to decode the lost symbols). Fountain codes are a class of erasure codes that can generate a very large amount of parity data from a given source block and thus, are considered rate less (i.e., any amount of FEC overhead can be delivered for any source block size or protection period). Raptor™ decoding can be implemented in complexity and memory constrained receivers, such as handset receivers, without the need for dedicated hardware due to the code's low computational complexity and efficient memory management.

Returning to FIG. 5, at the transmitter, designated generally at 510, K data source packets are input to an outer encoder 520. The outer encoder 520 receives the block of K input packets and encodes parities to create (N−K) parity packets. The N packets output by the outer encoder 520 as a single outer codeword are further encoded through an inner encoder 540. The inner encoded packets produced by the inner encoder 540 are bit-level interleaved and modulated (not shown), and then transmitted through a noisy communication channel shown diagrammatically at 550. The receiver, designated generally at 560, implements the appropriate demodulation and bit-level de-interleaving (not shown), and includes an inner decoder 570. The inner decoder 570 provides hard decisions regarding the bits of successfully decoded packets that are passed to the outer decoder 590. The outer decoder 590 performs decoding to recover, if possible, erased packets. The decoded packets are then passed from the outer decoder 590 to an upper layer (not shown). Descriptions of Raptor™ code encoding and decoding are provided by “Luby” and references therein.

In some implementations, the functions of the inner decoder 570 and the outer decoder 590 are combined and implemented iteratively by an iterative inner-outer decoder block (not shown). For example, the inner decoding of the inner decoder 570 can be based on extrinsic information produced by the outer decoder 590, and/or the outer decoding of the outer decoder 590 can be based on extrinsic information produced by the inner decoder 570. Iterative cooperation between the inner and outer codes using soft inputs and soft outputs can improve decoding performance over conventional concatenated decoding with hard inputs and hard outputs. Descriptions of iterative inner-outer decoding are provided by “Jiang” and references therein.

If a Raptor™ code is used for the outer code in the concatenated inner/outer coding structure of FIG. 5, various rates may be used to encode as a single outer codeword the multiple packets of the logical channel received as input to the outer encoder 520. For example, supported Raptor™ code rates can include ½, ¾, ⅞, and 15/16. Other rates can also be supported, as described below.

FIG. 6 illustrates an outer error control block structure for the encoding operation of the (N, K) outer code in the concatenated coding system (520 in FIG. 5). The outer error control block 600 is formed of N rows, where the top K rows each contain a source packet 610 (e.g., a systematic packet) as a data link layer packet (e.g., a MAC layer packet). The bottom R=N−K rows of the outer error control block 600 contain outer code parity packets 620. The entire error control block 600 is a single outer codeword. Each row of the outer error control block 600 forms the payload for one physical layer packet.

As an example for the MediaFLO™ broadcast system where the outer code is selected as a Raptor™ code, a Raptor™ encoder is applied to the MAC layer source packets in a MAC layer capsule of an MLC to generate the repair packets. The K MAC layer source packets in a MAC layer capsule of an MLC are the K source symbols of the Raptor™ code, where each source symbol can be of size 976 bits=122 bytes. The MLC can be formed of the K source symbols corresponding to the K MAC layer source packets in the MLC and R=N−K repair symbols (i.e., parity symbols) of 122 bytes each generated using the Raptor™ encoder. Each symbol can be identified by a unique implicit integer Encoding Symbol Identifier (ESI), where the ESI values from 0 to K−1 identify the source symbols and the ESI values from K to N−1 identify the repair symbols.

In some implementations, the value of K is a multiple of the Raptor™ encoding rate times 16. For example, for Raptor™ code rates of ½, ¾, ⅞, and 15/16, the value of K is a multiple of 8, 12, 14, or 15, respectively. In these cases, the value of N is a multiple of 16, and the value of R is a multiple of 8, 4, 2, or 1, respectively. For the MediaFLO™ broadcast system, the value of N needs to be a multiple of 4, so that the MAC layer packets of an MLC can be equally distributed over the four frames of a superframe.

If the number of MAC layer source packets in a MAC layer capsule of an MLC is less than K for a selected Raptor™ code rate, MAC layer stuffing packets can be added so that the total number of MAC layer source and stuffing packets in a MAC layer capsule of an MLC equals the value of K for the selected Raptor™ code rate. If MAC layer stuffing packets are used, the MAC layer source and stuffing packets are encoded jointly using the Raptor™ encoder to generate the R MAC layer repair packets.

In some implementations, instead of adding MAC layer stuffing packets, additional MAC layer repair packets can be generated and sent to improve error correction at a receiving device. As an example, the stream layer count of MAC layer packets can be used to determine the number of MAC layer source packets in a MAC layer capsule of an MLC. This number of MAC layer source packets can be used as the value of K when selecting the Raptor™ code rate to determine the total number of MAC layer packets for the Raptor™ error control block.

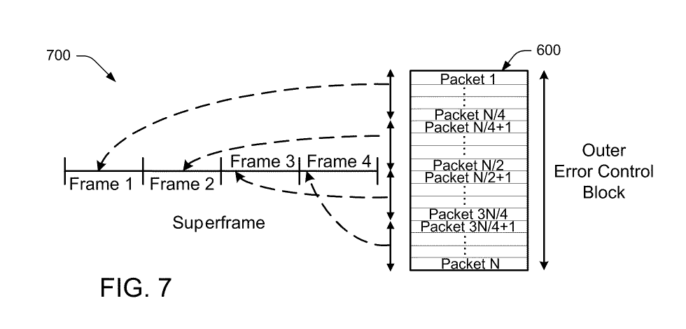

FIG. 7 illustrates the sequencing 700 of packets of the outer error control block 600 of FIG. 6 in a superframe. Each outer error control block 600 is split into four equal sub-blocks, and each sub-block is sent to the physical layer for transmission in a unique frame within a superframe. Each sub-block consists of a quarter of the rows in the outer error control block 600, i.e., N/4 MAC layer packets. Only one outer error control block 600, corresponding to one MAC layer capsule, is sent per superframe.

### Signaling for Indicating Outer Code and Outer Code Rates

Use of a new outer code (e.g., a Raptor™ code) in concatenated coding schemes for content delivery services may require new or modified signaling to indicate the new outer code and the outer code rate. The following signaling techniques are described for the MediaFLO™ broadcast system, although the techniques are generally applicable to other content delivery services.

For MediaFLO™, first and second versions of the Air Interface Specification (AIS) (i.e., The Telecommunications Industry Association (TIA) TIA-1099 and TIA 1099, Rev. A) define using a turbo code as the inner code for the physical layer and a Reed-Solomon code of length N=16 as the outer code for the MAC layer. The AIS specifies an outer code rate field of an MLC to indicate both the outer code and the outer code rate used at the MAC layer for that MLC. A 4-bit OuterCodeRate field defines the outer code and the outer code rate used for an MLC. Table 1 shows the currently defined values for the 4-bit OuterCodeRate field.

TABLE 1
OuterCodeRate Field Values

| Value | Meaning |
|---|---|
| ‘0000’ | None |
| ‘0001’ | Reed-Solomon encoding rate ⅞ |
| ‘0010’ | Reed-Solomon encoding rate ¾ |
| ‘0011’ | Reed-Solomon encoding rate ½ |

All other values are reserved for future use.

For a control channel MLC, the outer code and the outer code rate can be signaled by a ControlChannelOuterCodeRate field in the OIS. For an MLC carrying broadcast data, the outer code and the outer code rate can be signaled by an OuterCodeRate field defined per MLC in a control channel. If a new outer code and outer code rates are to be supported by the current AIS, these two fields need to accept new values.

In some implementations, a new set of values can be used for the OuterCodeRate fields to indicate new outer code and outer code rates. For example, the field values presently reserved for future use in the current AIS can be used to signal the new outer code and outer code rates. Table 2 is an extension of Table 1 and shows a new set of values using the field values presently reserved for future use in the current AIS. The four newly defined values signal four different code rates (i.e., ½, ¾, ⅞, and 15/16) for use with a Raptor™ code.

TABLE 2
Updated OuterCodeRate Field Values

| Value | Meaning |
|---|---|
| ‘0000’ | None |
| ‘0001’ | Reed-Solomon encoding rate ⅞ |
| ‘0010’ | Reed-Solomon encoding rate ¾ |
| ‘0011’ | Reed-Solomon encoding rate ½ |
| ‘0100’ | Raptor ™ encoding rate 15/16 |
| ‘0101’ | Raptor ™ encoding rate ⅞ |
| ‘0110’ | Raptor ™ encoding rate ¾ |
| ‘0111’ | Raptor ™ encoding rate ½ |

All other values are reserved for future use.

Thus, the newly defined values (i.e., ‘0100’ through ‘0111’) can be used to indicate the Raptor™ code and desired coding rate in the ControlChannelOuterCodeRate field in the OIS for a control channel MLC and in the OuterCodeRate field in a control channel defined for a particular MLC carrying broadcast data.

A third version of the AIS for MediaFLO™, i.e., TIA 1099 Rev. B, specifies the OuterCodeRate field values of ‘0100’ and ‘0101’ to indicate that a transmit mode is specific to Rev. B, as non-layered or layered, respectively. These transmit modes are referred to as PHY Type 2 transmit modes, while the transmit modes of TIA 1099 Rev. A are referred to as PHY Type 1 transmit modes. Thus, the newly defined values for the Raptor™ codes in Table 2 would need to be modified for compatibility with TIA 1099 Rev. B. As an example, instead of using the values ‘0100’ through ‘0111’ to indicate the Raptor™ code with rates 15/16, ⅞, ¾, and ½, the reserved values ‘1100’ through ‘1111’ could be used. Using other values reserved for future use is also possible. Alternatively, a new field can be defined to indicate the Raptor™ codes, to allow the reserved values of the OuterCodeRate field to remain unused, e.g., for defining future transmit modes.

For TIA 1099 Rev. B, the location of an MLC is described in an MLC Records Table or an Extended MLC Records Table in the SystemParameters Message of the OIS, where a particular MLC is identified by an MLC Identifier in the OIS. Mapping of flows to MLC Identifiers is done in Flow Description Messages (FDM) or Extended Flow Description Messages (EFDM) of a control channel. The FDM and EFDM also describe the physical layer characteristics of the respective MLC, including transmit mode and outer code rate. Extended MLC Records Table and EFDM were added to segregate information of flows carried by PHY Type 2 MLCs from those carried by PHY Type 1 MLCs.

Thus, the transmit mode and the outer code rate for a control channel MLC are specified by the SystemParameters Message of the OIS, and the transmit mode and the outer code rate for an MLC carrying broadcast data are specified by the FDM or the EFDM of a control channel.

If a Raptor™ code is used as the outer code at the MAC layer, many code rates are achievable, due to the rate-less nature of Raptor™ codes. Thus, it is preferable to be able to signal more code rate values to indicate more than the four Raptor™ code rates listed above. In particular, if additional MAC layer repair packets are generated instead of using MAC layer stuffing packets, the code rate preferably used to encode an MLC will depend on the length of the MLC and the number of MAC layer repair packets. It is also preferable to be able to change the outer code rate dynamically (e.g., on a superframe basis) for example, to allow targeting a desired decoding error probability to ensure constant coverage regardless of the outer code rate and/or the MLC length.

In some implementations, a new field (e.g., a 64-bit field) is defined in the FDM and EFDM of a control channel to serve as an extension to the OuterCodeRate field for MLCs carrying broadcast data. For example, one of the OuterCodeRate field values reserved for future use (e.g., ‘1111’) can be used to indicate the outer code (e.g., a Raptor™ code). The outer code rate can be indicated separately by using values in the newly defined field in the FDM and EFDM messages of the control channel. If the new field is larger than two bits, more than four outer code rates can be indicated, allowing a better granularity in setting the outer code rate. Similarly, a new field can be defined in the SystemParameters Message of the OIS to serve as an extension to the ControlChannelOuterCodeRate field for a control channel MLC. However, because parameters that do not vary on a superframe basis are sent in the control channel, the outer code rate for an MLC carrying broadcast data is not updatable on a superframe basis with this implementation.

In some implementations, the outer code rate for an MLC is updatable on a superframe basis by signaling the outer code rate or outer code rate changes in the OIS. For example, the reserved bits in the MLC Records Table and the Extended MLC Records Table in the SystemParameters Message of the OIS can be used to signal either the outer code rate or changes in the outer code rate relative to a reference outer code rate (e.g., a mean outer code rate, a maximum outer code rate, or a minimum outer code rate).

In one example, the outer code rate for an MLC carrying broadcast data is no longer signaled in the FDM or EFDM of a control channel. Instead, the outer code rate is signaled in the OIS using extra bits (e.g., an extra byte) in the MLC Records Table and the Extended MLC Records Table entries.

Overhead information conveyed to receiving devices in the OIS can be decoded at the start of a superframe for use in decoding MLCs within the same superframe. The overhead information includes information that can change on a superframe basis, including time-frequency allocations for each MLC. This information can also be embedded as embedded overhead information in the traffic payload. The two different mechanisms are used for sending the allocation information, because the receiving devices use each mechanism in a different set of scenarios. Descriptions of the OIS and embedded overhead information are provided by “Chari” and references therein. In particular, while successfully decoding an MLC, a receiving device can use the embedded overhead information to determine the “on” time for the MLC in the next superframe. One advantage to this mechanism is that the receiving device does not have to wake up to decode the OIS in the next superframe, leading to reduced power consumption.

Because overhead information of the OIS can be used to decode MLCs of the same superframe, signaling the outer code rate for an MLC using the OIS allows the outer code rate to change more quickly than through signaling in a control channel. If the outer code rate is signaled in a control channel, additional battery power may be needed, and the change in the outer code rate can add delay in the processing of the superframe, because the control channel needs to be processed before the MLC can be decoded. Thus, for faster updates, it can be advantageous to signal the outer code rate or outer code rate changes in the OIS.

If the outer code rate for an MLC is signaled by the OIS, such that the outer code rate is updatable on a superframe basis, the outer code rate needs to also be signaled with embedded overhead information in the traffic payload, as described above for the time-frequency allocations. In TIA 1099 Rev. B, the embedded overhead information that allows a receiving device to know the allocation of an MLC in the next superframe without reading the OIS only has four extra available bits. Thus, the above example for signaling the outer code rate using extra bits in the OIS is limited by the available extra bits in the embedded overhead information. As a result, if more than four bits are needed to signal the outer code rate, either a change to the structure of the MAC trailer carrying the embedded overhead information is needed or the receiving device will need to read the OIS every superframe.

In another example, instead of signaling the outer code rate in the extra bits of the OIS, changes in the outer code rate relative to a reference outer code rate can be signaled in the extra bits of the OIS. Here, a reference outer code rate (e.g., a mean outer code rate, a maximum outer code rate, or a minimum outer code rate) of an MLC carrying broadcast data can be signaled in the FDM or EFDM of a control channel. Additionally, changes in the outer code rate relative to the reference outer code rate can be signaled in the OIS using extra bits (e.g., four extra reserved bits) in the MLC Records Table and the Extended MLC Records Table entries. If four bits are sufficient to signal the difference between the outer code rate and the reference outer code, the difference can also be signaled using the four extra available bits of the embedded overhead information in the traffic payload. Thus, this technique allows the MLC acquisition and the MAC layer architecture of TIA 1099 Rev. A and Rev. B to be used to determine both the MLC time-frequency allocation and the outer code rate. The difference in outer code rate can be signaled using four bits (i.e., 16 steps) to indicate, for example, seven steps up, no change, and eight steps down in the reference outer code rate specified in the control channel for MLCs carrying broadcast data and in the OIS for a control channel MLC.

In other implementations, the difference in the outer code rate relative to a reference code rate can be signaled, for example, by indicating the outer code rate steps in a control channel, by defining a new field for the code rate difference, or by extending the length of stream and/or MAC layer trailers.

### Outer Error Control Block for Jointly Encoding Data of Multiple Superframes

The use of an outer code (e.g., a Raptor™ code) that is considered rate-less has the advantage of allowing any amount of FEC overhead to be delivered for any source block size or protection period. Thus, the length of the outer codeword is not limited to the MLC length in a MAC layer capsule. Longer codewords generated by jointly encoding the data of an MLC for transmission on multiple superframes can provide even more time diversity than the codewords described above. The signaling of the outer code and outer code rate can generally be as described in the above techniques.

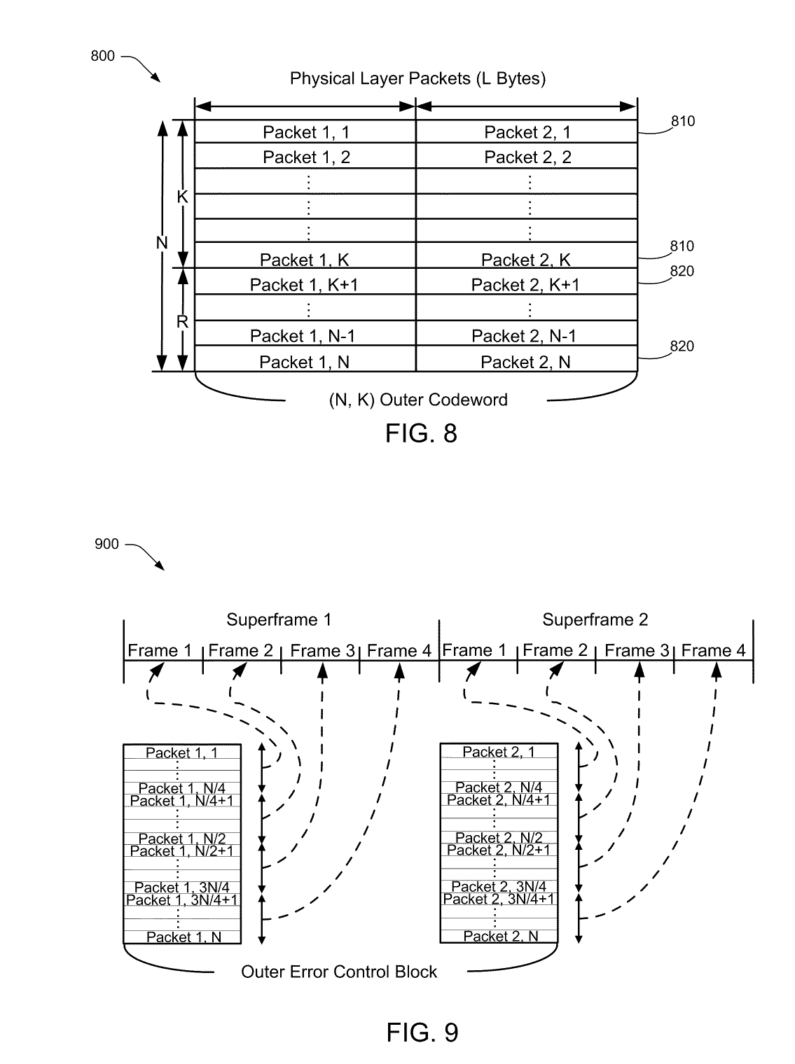

FIG. 8 illustrates an outer error control block structure for jointly encoding data of multiple superframes. In the example of FIG. 8, the outer error control block 800 is generated by jointly encoding MLC data of two superframes, although the number of superframes jointly encoded by this technique can be higher. The MAC layer packets of a first MAC layer capsule, corresponding to a first superframe, are indicated as Packet 1, 1, . . . , Packet 1, N. Similarly, the MAC layer packets of a second MAC layer capsule, corresponding to a second superframe, are indicated as Packet 2, 1, . . . , Packet 2, N. The MAC layer source packets 810 (e.g., systematic source packets) are sent in their respective superframe. The MAC layer repair packets 820 are sent in the respective superframe in proportion to the MAC layer source packets 810, as the same outer code rate applies to both MAC layer capsules. In this example, the outer code rate is K/N, where the number of MAC layer source packets and MAC layer stuffing packets (if any) is equal to 2·K, and the number of MAC layer repair packets is equal to 2·R for the outer error control block 800.

Signaling can be used to determine which superframes are jointly encoded. Alternatively, if M superframes are jointly encoded, the M superframes can be indicated, for example, as the superframes where the floor of the system time divided by M has the same value.

FIG. 9 illustrates the sequencing 900 of packets of the outer error control block 800 of FIG. 8 across multiple superframes. In the example of FIG. 9, the outer error control block is generated by jointly encoding MLC data of two superframes. In some implementations, the total number of MAC layer packets of the outer error control block 800 is a multiple of 32. In other implementations, the total number of MAC layer packets of the outer error control block is a multiple of 4·M for M jointly encoded superframes, such that the total number of MAC layer packets of the outer error control block is evenly divided among the 4·M frames of the M jointly encoded superframes.

Process of Encoding Data of a Superframe with Signaling in a Control Channel

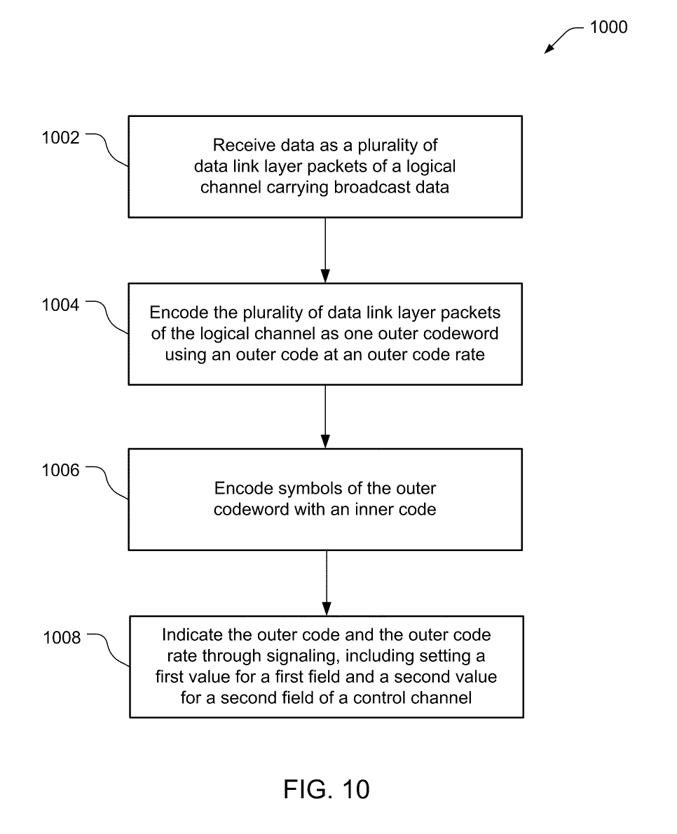

Referring to FIG. 10, with further reference to FIG. 5, a process 1000 of encoding data for transmission on a communication link includes the stages shown. The process 1000 is exemplary only and not limiting. The process 1000 can be altered, e.g., by having stages added, removed, or rearranged.

At stage 1002, an input (e.g., an input on a source transmitter side of the communication link) receives data to be communicated to a device. The data is received as multiple data link layer packets of a logical channel carrying broadcast data. For example, the data can be received as multiple MAC layer packets of a control channel MLC or an MLC for broadcasting data. The communication link is part of a content delivery system, e.g., the MediaFLO™ broadcast system. In some implementations, the received data represents content to be communicated to the device, where the content includes at least one of video media, audio media, or textual media.

At stage 1004, an outer encoder (e.g., the outer encoder 520 of FIG. 5) encodes the multiple data link layer packets of the logical channel as one outer codeword using an outer code at an outer code rate. For example, a Raptor™ encoder can encode the MAC layer source packets of a MAC layer capsule of an MLC as a single outer codeword. In some implementations, the outer code rate is determined at least in part by the multiple data link layer packets of the logical channel. For example, if a Raptor™ code is used as the outer code, the number of MAC layer source packets of a MAC layer capsule can be used to determine the outer code rate to eliminate the need for MAC layer stuffing packets.

At stage 1006, an inner encoder (e.g., the inner encoder 540 of FIG. 5) encodes symbols of the outer codeword with an inner code. For example, a turbo encoder can encode each of the symbols of the outer codeword generated by a Raptor™ encoder for the MAC layer capsule as in TIA 1099 Rev. A, where each symbol is a MAC layer packet. In another example, a turbo encoder can encode each of a group of 16 symbols of the outer codeword generated by a Raptor™ encoder for the MAC layer capsule as in the PHY Type 2 transmit modes of TIA 1099 Rev. B.

At stage 1008, a processor (e.g., a processor on the source transmitter side of the communication link) indicates the outer code and the outer code rate through signaling, including setting a first value for a first field (e.g., an OuterCodeRate field) of a control channel and setting a second value for a second field (e.g., a new field defined in the FDM and EFDM) of the control channel. The first value is determined by the outer code, while the second value set is determined by the outer code rate.

Process of Encoding Data of a Superframe with Signaling of a Difference in Code Rate

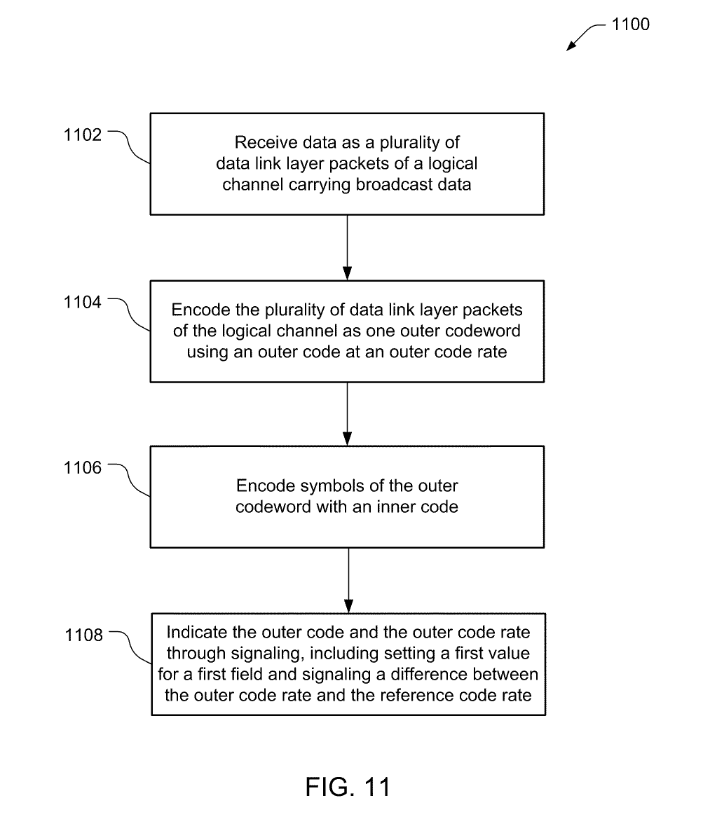

Referring to FIG. 11, with further reference to FIG. 5, another process 1100 of encoding data for transmission on a communication link includes the stages shown. The process 1100 is exemplary only and not limiting. The process 1100 can be altered, e.g., by having stages added, removed, or rearranged. The first three stages of FIG. 11 correspond to the first three stages of FIG. 10.

At stage 1102, an input (e.g., an input on a source transmitter side of the communication link) receives data to be communicated to a device. The data is received as multiple data link layer packets of a logical channel carrying broadcast data. The communication link is part of a content delivery system, e.g., the MediaFLO™ broadcast system. In some implementations, the received data represents content to be communicated to the device, where the content includes at least one of video media, audio media, or textual media.

At stage 1104, an outer encoder (e.g., the outer encoder 520 of FIG. 5) encodes the multiple data link layer packets of the logical channel as one outer codeword using an outer code at an outer code rate. For example, a Raptor™ encoder can encode the MAC layer source packets of a MAC layer capsule of an MLC as a single outer codeword. In some implementations, the outer code rate is determined at least in part by the multiple data link layer packets of the logical channel. For example, if a Raptor™ code is used as the outer code, the number of MAC layer source packets of a MAC layer capsule can be used to determine the outer code rate to eliminate the need for MAC layer stuffing packets.

At stage 1106, an inner encoder (e.g., the inner encoder 540 of FIG. 5) encodes symbols of the outer codeword with an inner code. For example, a turbo encoder can encode each of the symbols of the outer codeword generated by a Raptor™ encoder for the MAC layer capsule as in TIA 1099 Rev. A, where each symbol is a MAC layer packet. In another example, a turbo encoder can encode each of a group of 16 symbols of the outer codeword generated by a Raptor™ encoder for the MAC layer capsule as in the PHY Type 2 transmit modes of TIA 1099 Rev. B.

At stage 1108, a processor (e.g., a processor on the source transmitter side of the communication link) indicates the outer code and the outer code rate through signaling, including setting a first value for a first field of a control channel and signaling a difference between the outer code rate and a reference code rate. The first value is determined by the outer code and the reference code rate. The difference between the outer code rate and the reference code rate is signaled using first overhead information symbols describing the logical channel. The outer code rate is updatable on a superframe basis. In some implementations, the difference between the outer code rate and the reference code rate can also be indicated using overhead information symbols embedded in the logical channel.

Process of Encoding Data of a Superframe with Signaling Using Overhead Information

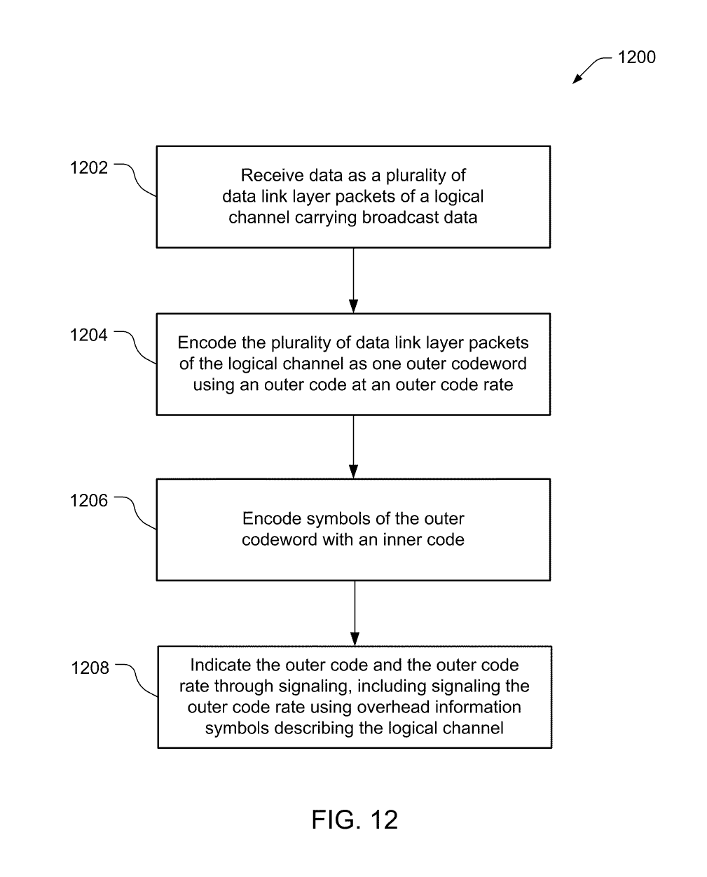

Referring to FIG. 12, with further reference to FIG. 5, yet another process 1200 of encoding data for transmission on a communication link includes the stages shown. The process 1200 is exemplary only and not limiting. The process 1200 can be altered, e.g., by having stages added, removed, or rearranged. The first three stages of FIG. 12 correspond to the first three stages of FIG. 10.

At stage 1202, an input (e.g., an input on a source transmitter side of the communication link) receives data to be communicated to a device. The data is received as multiple data link layer packets of a logical channel carrying broadcast data. The communication link is part of a content delivery system, e.g., the MediaFLO™ broadcast system. In some implementations, the received data represents content to be communicated to the device, where the content includes at least one of video media, audio media, or textual media.

At stage 1204, an outer encoder (e.g., the outer encoder 520 of FIG. 5) encodes the multiple data link layer packets of the logical channel as one outer codeword using an outer code at an outer code rate. For example, a Raptor™ encoder can encode the MAC layer source packets of a MAC layer capsule of an MLC as a single outer codeword. In some implementations, the outer code rate is determined at least in part by the multiple data link layer packets of the logical channel. For example, if a Raptor™ code is used as the outer code, the number of MAC layer source packets of a MAC layer capsule can be used to determine the outer code rate to eliminate the need for MAC layer stuffing packets.

At stage 1206, an inner encoder (e.g., the inner encoder 540 of FIG. 5) encodes symbols of the outer codeword with an inner code. For example, a turbo encoder can encode each of the symbols of the outer codeword generated by a Raptor™ encoder for the MAC layer capsule as in TIA 1099 Rev. A, where each symbol is a MAC layer packet. In another example, a turbo encoder can encode each of a group of 16 symbols of the outer codeword generated by a Raptor™ encoder for the MAC layer capsule as in the PHY Type 2 transmit modes of TIA 1099 Rev. B.

At stage 1208, a processor (e.g., a processor on the source transmitter side of the communication link) indicates the outer code and the outer code rate through signaling, including signaling the outer code rate using overhead information symbols describing the logical channel. The outer code rate is updatable on a superframe basis.

### Process of Decoding Data

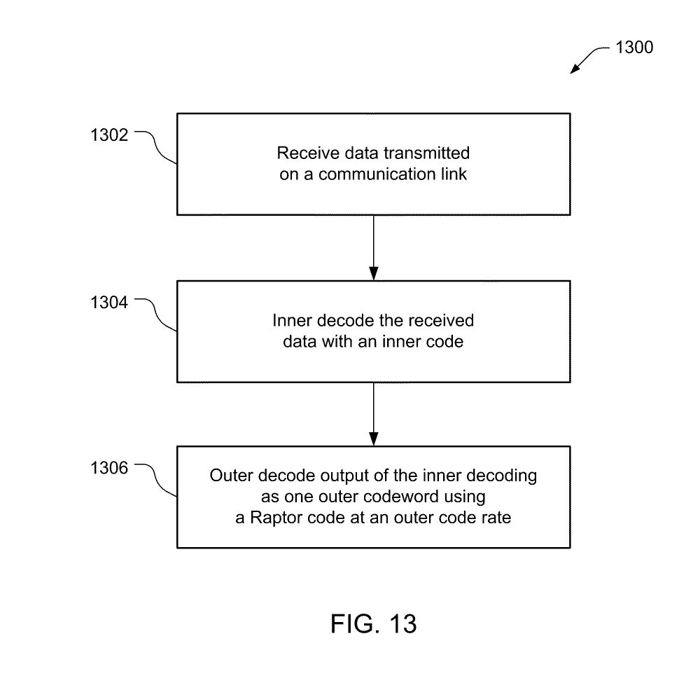

Referring to FIG. 13, with further reference to FIG. 5, a process 1300 of decoding data transmitted on a communication link includes the stages shown. The process 1300 is exemplary only and not limiting. The process 1300 can be altered, e.g., by having stages added, removed, or rearranged.

At stage 1302, a receiver (e.g., a receiver of a receiving device) receives data transmitted on the communication link. The communication link is part of a content delivery system, e.g., the MediaFLO™ broadcast system. In some implementations, the data transmitted on the communication link represents content to be communicated to a receiving device, where the content includes at least one of video media, audio media, or textual media.

At stage 1304, an inner decoder (e.g., the inner decoder 570 of FIG. 5) inner decodes the received data with an inner code. For example, the received data can be decoded with a turbo decoder.

At stage 1306, an outer decoder (e.g., the outer decoder 590 of FIG. 5) outer decodes output of the inner decoding as one outer codeword using a Raptor™ code at an outer code rate. For example, a Raptor™ decoder can decode the output of a turbo decoder as one outer codeword that represents a MAC layer capsule of an MLC. In some implementations, the inner decoding is based on extrinsic information produced by the outer decoding, and the outer decoding is based on extrinsic information produced by the inner decoding.

### Process of Encoding Data Across Multiple Superframes

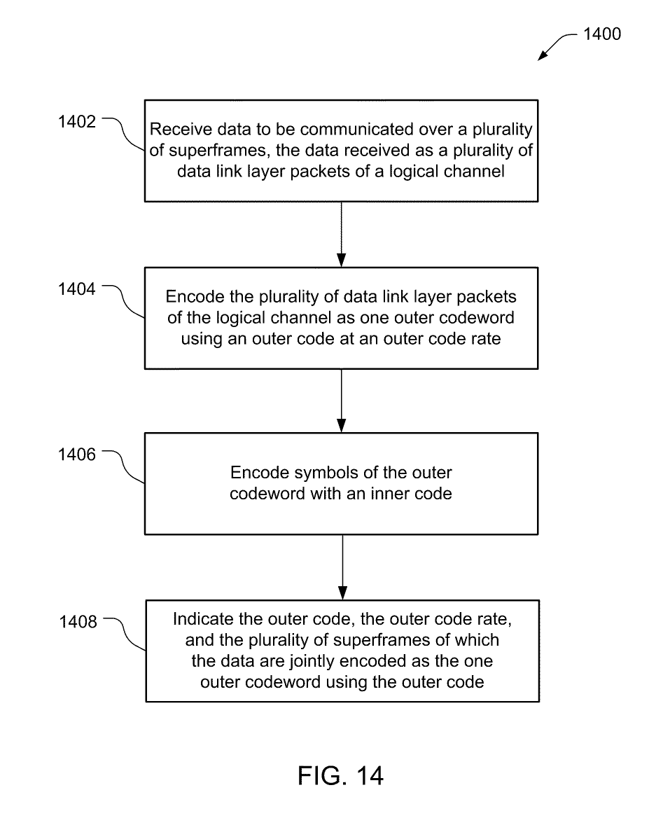

Referring to FIG. 14, a process 1400 of encoding data for transmission on a communication link includes the stages shown. The process 1400 is exemplary only and not limiting. The process 1400 can be altered, e.g., by having stages added, removed, or rearranged.

At stage 1402, an input (e.g., an input on a source transmitter side of the communication link) receives data to be communicated over multiple superframes to a device, where the data is received as multiple data link layer packets of a logical channel. For example, the data can be received as multiple MAC layer packets of a control channel MLC or an MLC for broadcasting data. In some implementations, the communication link is part of a content delivery system, e.g., the MediaFLO™ broadcast system. In some implementations, the received data represents content to be communicated to the device, where the content includes at least one of video media, audio media, or textual media.

At stage 1404, an outer encoder (e.g., the outer encoder 520 of FIG. 5) encodes the multiple data link layer packets of the logical channel as one outer codeword using an outer code at an outer code rate. For example, a Raptor™ encoder can encode the MAC layer source packets of multiple MAC layer capsules of an MLC as a single outer codeword. In some implementations, the outer code rate is determined at least in part by the multiple data link layer packets of the logical channel. For example, if a Raptor™ code is used as the outer code, the number of MAC layer source packets of the multiple MAC layer capsules can be used to determine the outer code rate to eliminate the need for MAC layer stuffing packets.

At stage 1406, an inner encoder (e.g., the inner encoder 540 of FIG. 5) encodes the one outer codeword with an inner code. For example, a turbo encoder can encode the single outer codeword generated by a Raptor™ encoder for the multiple MAC layer capsules.

At stage 1408, a processor (e.g., a processor on the source transmitter side of the communication link) indicates the outer code, the outer code rate, and the multiple superframes of which the data are jointly encoded as the one outer codeword using the outer code. For example, signaling can be used to determine which superframes are jointly encoded.

### Considerations Regarding the Description

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), a digital signal processing device (DSPD), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The blocks of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software executed by a processor, firmware, or any combination thereof. If implemented in software executed by a processor, the functions may be stored on or transmitted over as one or more instructions or code on a computer-readable medium. Computer-readable media includes both tangible and/or non-transitory computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of computer-readable media.

The previous description is provided to enable any person skilled in the art to make and/or use the apparatus, systems, and methods described. Various modifications to the disclosure will be readily apparent to those skilled in the art, and the generic principles defined herein may be applied to other variations without departing from the spirit or scope of the disclosure. Thus, the disclosure is not to be limited to the examples and designs described herein but is to be accorded the widest scope consistent with the principles and novel features disclosed herein.

1. A method of encoding data for transmission on a communication link of a content delivery system, the method comprising:
receiving data to be communicated to a device, the data received as a plurality of data link layer packets of a logical channel carrying broadcast data;
encoding the plurality of data link layer packets of the logical channel as one outer codeword using an outer code at an outer code rate;
encoding symbols of the outer codeword with an inner code; and
indicating the outer code and the outer code rate through signaling, including setting a first value for a first field of a control channel and setting a second value for a second field of the control channel, wherein the first value is determined by the outer code, and the second value is determined by the outer code rate.

2. The method of claim 1, wherein the outer code is a Raptor code.

3. The method of claim 1, further comprising determining the outer code rate at least in part by the plurality of data link layer packets of the logical channel.

4. A method of encoding data for transmission on a communication link of a content delivery system, the method comprising:
receiving data to be communicated to a device, the data received as a plurality of data link layer packets of a logical channel carrying broadcast data;
encoding the plurality of data link layer packets of the logical channel as one outer codeword using an outer code at an outer code rate;
encoding symbols of the outer codeword with an inner code; and
indicating the outer code and the outer code rate through signaling, including setting a first value for a first field of a control channel, the first value determined by the outer code and a reference code rate, and signaling a difference between the outer code rate and the reference code rate using first overhead information symbols describing the logical channel, wherein the outer code rate is updatable on a superframe basis.

5. The method of claim 4, further comprising indicating the difference between the outer code rate and the reference code rate using second overhead information symbols embedded in the logical channel.

6. The method of claim 4, wherein the outer code is a Raptor code.

7. The method of claim 4, further comprising determining the outer code rate at least in part by the plurality of data link layer packets of the logical channel.

8. A method of encoding data for transmission on a communication link of a content delivery system, the method comprising:
receiving data to be communicated to a device, the data received as a plurality of data link layer packets of a logical channel carrying broadcast data;
encoding the plurality of data link layer packets of the logical channel as one outer codeword using an outer code at an outer code rate;
encoding symbols of the outer codeword with an inner code; and
indicating the outer code and the outer code rate through signaling, including signaling the outer code rate using overhead information symbols describing the logical channel, wherein the outer code rate is updatable on a superframe basis.

9. The method of claim 8, wherein the outer code is a Raptor code.

10. The method of claim 8, further comprising determining the outer code rate at least in part by the plurality of data link layer packets of the logical channel.

11. A method of decoding data transmitted on a communication link of a content delivery system, the method comprising:
receiving data transmitted on the communication link;
inner decoding the received data with an inner code; and
outer decoding output of the inner decoding as one outer codeword using a Raptor code at an outer code rate,
wherein the inner decoding is based on first extrinsic information produced by the outer decoding, and the outer decoding is based on second extrinsic information produced by the inner decoding.

12. A method of encoding data for transmission on a communication link, the method comprising:
receiving data to be communicated over a plurality of superframes to a device, the data received as a plurality of data link layer packets of a logical channel;
encoding the plurality of data link layer packets of the logical channel as one outer codeword using an outer code at an outer code rate;
encoding symbols of the outer codeword with an inner code; and
indicating the outer code, the outer code rate, and the plurality of superframes of which the data are jointly encoded as the outer codeword using the outer code.

13. The method of claim 12, wherein
the communication link is part of a content delivery system; and
the outer code is a Raptor code.

14. An apparatus configured to encode data for transmission on a communication link of a content delivery system, the apparatus comprising:
an input configured to receive data to be communicated to a device, the data received as a plurality of data link layer packets of a logical channel carrying broadcast data;
an outer encoder communicatively coupled to the input and configured to encode the plurality of data link layer packets of the logical channel as one outer codeword using an outer code at an outer code rate;
an inner encoder communicatively coupled to the outer encoder and configured to encode symbols of the outer codeword with an inner code; and
a processor communicatively coupled to the inner encoder and configured to indicate the outer code and the outer code rate through signaling, including setting a first value for a first field of a control channel and setting a second value for a second field of the control channel, wherein the first value is determined by the outer code, and the second value is determined by the outer code rate.

15. The apparatus of claim 14, wherein the outer code is a Raptor code.

16. The apparatus of claim 14, wherein the processor is further configured to determine the outer code rate at least in part by the plurality of data link layer packets of the logical channel.

17. An apparatus configured to encode data for transmission on a communication link of a content delivery system, the apparatus comprising:
an input configured to receive data to be communicated to a device, the data received as a plurality of data link layer packets of a logical channel carrying broadcast data;
an outer encoder communicatively coupled to the input and configured to encode the plurality of data link layer packets of the logical channel as one outer codeword using an outer code at an outer code rate;
an inner encoder communicatively coupled to the outer encoder and configured to encode symbols of the outer codeword with an inner code; and
a processor communicatively coupled to the inner encoder and configured to indicate the outer code and the outer code rate through signaling, including setting a first value for a first field of a control channel, the first value determined by the outer code and a reference code rate, and signaling a difference between the outer code rate and the reference code rate using first overhead information symbols describing the logical channel, wherein the outer code rate is updatable on a superframe basis.

18. The apparatus of claim 17, wherein the processor is further configured to indicate the difference between the outer code rate and the reference code rate using second overhead information symbols embedded in the logical channel.

19. The apparatus of claim 17, wherein the outer code is a Raptor code.

20. The apparatus of claim 17, wherein the processor is further configured to determine the outer code rate at least in part by the plurality of data link layer packets of the logical channel.

21. An apparatus configured to encode data for transmission on a communication link of a content delivery system, the apparatus comprising:
an input configured to receive data to be communicated to a device, the data received as a plurality of data link layer packets of a logical channel carrying broadcast data;
an outer encoder communicatively coupled to the input and configured to encode the plurality of data link layer packets of the logical channel as one outer codeword using an outer code at an outer code rate;
an inner encoder communicatively coupled to the outer encoder and configured to encode symbols of the outer codeword with an inner code; and
a processor communicatively coupled to the inner encoder and configured to indicate the outer code and the outer code rate through signaling, including signaling the outer code rate using overhead information symbols describing the logical channel, wherein the outer code rate is updatable on a superframe basis.

22. The apparatus of claim 21, wherein the outer code is a Raptor code.

23. The apparatus of claim 21, wherein the processor is further configured to determine the outer code rate at least in part by the plurality of data link layer packets of the logical channel.

24. An apparatus configured to decode data transmitted on a communication link of a content delivery system, the apparatus comprising:
an input configured to receive data transmitted on the communication link;
an inner decoder communicatively coupled to the input and configured to decode the received data with an inner code; and
an outer decoder communicatively coupled to the inner decoder and configured to decode output of the inner decoder as one outer codeword using a Raptor code at an outer code rate,
wherein the inner decoding is based on first extrinsic information produced by the outer decoding, and the outer decoding is based on second extrinsic information produced by the inner decoding.

25. An apparatus configured to encode data for transmission on a communication link, the apparatus comprising:
an input configured to receive data to be communicated over a plurality of superframes to a device, the data received as a plurality of data link layer packets of a logical channel;
an outer encoder communicatively coupled to the input and configured to encode the plurality of data link layer packets of the logical channel as one outer codeword using an outer code at an outer code rate;
an inner encoder communicatively coupled to the outer encoder and configured to encode symbols of the outer codeword with an inner code; and
a processor communicatively coupled to the inner encoder and configured to indicate the outer code, the outer code rate, and the plurality of superframes of which the data are jointly encoded as the outer codeword by the outer encoder.

26. The apparatus of claim 25, wherein
the communication link is part of a content delivery system; and
the outer encoder is a Raptor encoder.

27. A computer program product comprising:
a processor-readable medium storing processor-readable instructions configured to cause a processor to:
receive data to be communicated to a device by transmission on a communication link of a content delivery system, the data received as a plurality of data link layer packets of a logical channel carrying broadcast data;
encode the plurality of data link layer packets of the logical channel as one outer codeword using an outer code at an outer code rate;
encode symbols of the outer codeword with an inner code; and
indicate the outer code and the outer code rate through signaling, including setting a first value for a first field of a control channel and setting a second value for a second field of the control channel, wherein the first value is determined by the outer code, and the second value is determined by the outer code rate.

28. The product of claim 27, wherein the outer code is a Raptor code.

29. The product of claim 27, wherein the instructions are further configured to cause the processor to determine the outer code rate at least in part by the plurality of data link layer packets of the logical channel.

30. A computer program product comprising:
a processor-readable medium storing processor-readable instructions configured to cause a processor to:
receive data to be communicated to a device by transmission on a communication link of a content delivery system, the data received as a plurality of data link layer packets of a logical channel carrying broadcast data;
encode the plurality of data link layer packets of the logical channel as one outer codeword using an outer code at an outer code rate;
encode symbols of the outer codeword with an inner code; and
indicate the outer code and the outer code rate through signaling, including setting a first value for a first field of a control channel, the first value determined by the outer code and a reference code rate, and signaling a difference between the outer code rate and the reference code rate using first overhead information symbols describing the logical channel, wherein the outer code rate is updatable on a superframe basis.

31. The product of claim 30, wherein the instructions are further configured to cause the processor to indicate the difference between the outer code rate and the reference code rate using second overhead information symbols embedded in the logical channel.

32. The product of claim 30, wherein the outer code is a Raptor code.

33. The product of claim 30, wherein the instructions are further configured to cause the processor to determine the outer code rate at least in part by the plurality of data link layer packets of the logical channel.

34. A computer program product comprising:
a processor-readable medium storing processor-readable instructions configured to cause a processor to:
receive data to be communicated to a device by transmission on a communication link of a content delivery system, the data received as a plurality of data link layer packets of a logical channel carrying broadcast data;
encode the plurality of data link layer packets of the logical channel as one outer codeword using an outer code at an outer code rate;
encode symbols of the outer codeword with an inner code; and
indicate the outer code and the outer code rate through signaling, including signaling the outer code rate using overhead information symbols describing the logical channel, wherein the outer code rate is updatable on a superframe basis.

35. The product of claim 34, wherein the outer code is a Raptor code.

36. The product of claim 34, wherein the instructions are further configured to cause the processor to determine the outer code rate at least in part by the plurality of data link layer packets of the logical channel.

37. A computer program product comprising:
a processor-readable medium storing processor-readable instructions configured to cause a processor to:
receive data transmitted on a communication link;
inner decode the received data with an inner code; and
outer decode output of the inner decoding as one outer codeword using a Raptor code at an outer code rate,
wherein the inner decoding is based on first extrinsic information produced by the outer decoding, and the outer decoding is based on second extrinsic information produced by the inner decoding.

38. A computer program product comprising:
a processor-readable medium storing processor-readable instructions configured to cause a processor to:
receive data to be communicated over a plurality of superframes to a device by transmission on a communication link, the data received as a plurality of data link layer packets of a logical channel;
encode the plurality of data link layer packets of the logical channel as one outer codeword using an outer code at an outer code rate;
encode symbols of the outer codeword with an inner code; and
indicate the outer code, the outer code rate, and the plurality of superframes of which the data are jointly encoded as the outer codeword using the outer code.

39. The product of claim 38, wherein
the communication link is part of a content delivery system; and
the outer code is a Raptor code.

40. An apparatus configured to encode data for transmission on a communication link of a content delivery system, the apparatus comprising:
means for receiving data to be communicated to a device, the data received as a plurality of data link layer packets of a logical channel carrying broadcast data;
means for encoding the plurality of data link layer packets of the logical channel as one outer codeword using an outer code at an outer code rate;
means for encoding symbols of the outer codeword with an inner code; and
means for indicating the outer code and the outer code rate through signaling, including setting a first value for a first field of a control channel and setting a second value for a second field of the control channel, wherein the first value is determined by the outer code, and the second value is determined by the outer code rate.

41. The apparatus of claim 40, wherein the outer code is a Raptor code.

42. The apparatus of claim 40, further comprising means for determining the outer code rate at least in part by the plurality of data link layer packets of the logical channel.

43. An apparatus configured to encode data for transmission on a communication link of a content delivery system, the apparatus comprising:
means for receiving data to be communicated to a device, the data received as a plurality of data link layer packets of a logical channel carrying broadcast data;
means for encoding the plurality of data link layer packets of the logical channel as one outer codeword using an outer code at an outer code rate;
means for encoding symbols of the outer codeword with an inner code; and
means for indicating the outer code and the outer code rate through signaling, including setting a first value for a first field of a control channel, the first value determined by the outer code and a reference code rate, and signaling a difference between the outer code rate and the reference code rate using first overhead information symbols describing the logical channel, wherein the outer code rate is updatable on a superframe basis.

44. The apparatus of claim 43, further comprising means for indicating the difference between the outer code rate and the reference code rate using second overhead information symbols embedded in the logical channel.

45. The apparatus of claim 43, wherein the outer code is a Raptor code.

46. The apparatus of claim 43, further comprising means for determining the outer code rate at least in part by the plurality of data link layer packets of the logical channel.

47. An apparatus configured to encode data for transmission on a communication link of a content delivery system, the apparatus comprising:
means for receiving data to be communicated to a device, the data received as a plurality of data link layer packets of a logical channel carrying broadcast data;
means for encoding the plurality of data link layer packets of the logical channel as one outer codeword using an outer code at an outer code rate;
means for encoding symbols of the outer codeword with an inner code; and
means for indicating the outer code and the outer code rate through signaling, including signaling the outer code rate using overhead information symbols describing the logical channel, wherein the outer code rate is updatable on a superframe basis.

48. The apparatus of claim 47, wherein the outer code is a Raptor code.

49. The apparatus of claim 47, further comprising means for determining the outer code rate at least in part by the plurality of data link layer packets of the logical channel.

50. An apparatus configured to decode data transmitted on a communication link of a content delivery system, the apparatus comprising:
means for receiving data transmitted on the communication link;
means for inner decoding the received data with an inner code; and
means for outer decoding output of the inner decoding as one outer codeword using a Raptor code at an outer code rate,
wherein the inner decoding is based on first extrinsic information produced by the outer decoding, and the outer decoding is based on second extrinsic information produced by the inner decoding.

51. An apparatus configured to encode data for transmission on a communication link, the apparatus comprising:
means for receiving data to be communicated over a plurality of superframes to a device, the data received as a plurality of data link layer packets of a logical channel;
means for encoding the plurality of data link layer packets of the logical channel as one outer codeword using an outer code at an outer code rate;
means for encoding symbols of the outer codeword with an inner code; and
means for indicating the outer code, the outer code rate, and the plurality of superframes of which the data are jointly encoded as the outer codeword using the outer code.

52. The apparatus of claim 51, wherein
the communication link is part of a content delivery system; and
the outer code is a Raptor code.
